(19) United States
(12) Patent Application Publication
(10) Pub. No.: US 2023/0061988 A1
(43) Pub. Date: Mar. 2, 2023

(54) Ball Coupling

(71) Applicant: Bartlett Transport Improvements Pty. Ltd., Hallam (AU)

(72) Inventors: Allan James Bartlett, Hallam (AU); Geoffrey Norman Bartlett, Hallam (AU)

(21) Appl. No.: 17/895,649

(22) Filed: Aug. 25, 2022

(30) Foreign Application Priority Data
Aug. 25, 2021 (AU) 2021221782
Aug. 25, 2021 (AU) 2021902761
Nov. 17, 2021 (AU) 2021269366

(51) Int. Cl. B60D 1/06; B60D 1/28

(52) U.S. Cl. CPC B60D 1/065; B60D 1/28

(57) ABSTRACT

A ball coupling device includes a socket assembly, configured to assume an operative condition in which it defines a socket to capture a tow ball such that there is formed a sliding fit, permitting relative rotation, between the tow ball and socket or assembly and to assume an inoperative condition whereby the tow ball and assembly can be decoupled. The assembly being configured to define in the operative condition an opening, disposed about a neck via which the tow ball is supported, having a width, parallel to a rotational axis extending centrally through the tow ball and perpendicular to a central axis of the tow ball that extends top-to-bottom therethrough, sufficient that the neck passes through the opening, and a length sufficient to permit relative displacement between the neck and assembly and thus relative rotation between the tow ball and the assembly or device about the rotational axis.

### RELATED APPLICATIONS

The contents of Australian patent application nos. 2021902761, 2021221782 and 2021269366 are incorporated herein by reference in their entirety.

### FIELD OF THE INVENTION

The invention relates generally to coupling devices, especially for use in towing applications.

### BACKGROUND

In order to tow one vehicle (“towed vehicle”) behind another vehicle (“towing vehicle”), an articulated coupling, also known as a “ball coupling”, is required. The coupling serves to maintain connection between the towed vehicle and towing vehicle, while allowing some independence of movement between the two. This enables the two vehicles to perform manoeuvres, such as turning more easily. One problem with prior art couplings is that they do not provide sufficient articulation for some applications in which a user may wish to tow a vehicle. In particular, if there is insufficient articulation in the coupling to allow one of the vehicles to move independently of the other, when traversing uneven road, the stress on components comprising or connected to the coupling can cause them to fail.

Ball couplings usually do not have off-road capability, and, where they do, are generally clumsy adaptions of ones which do not.

There exist other kinds of coupling that are off-road capable, including hook-type couplings, many of which are comparatively crude and/or small.

Ball coupling design is regulated in particular countries, including in Australia—by Australian Standard AS4177, entitled “Caravan and light trailer towing components”, and AS3819.1-1998, entitled “Heavy duty towing components 70 mm and 110 mm diameter towballs for heavy duty couplings”, the disclosures in which are incorporated herein by reference.

### SUMMARY

According to a first aspect of the present invention, there is provided a ball coupling device comprising a socket assembly (10), configured to assume an operative condition in which it defines a socket to capture a tow ball such that there is formed a sliding fit, permitting relative rotation, between the tow ball and socket or assembly, and to assume an inoperative condition whereby the tow ball and assembly can be decoupled, the assembly being configured to define in the operative condition an opening (2), disposed about a neck (104) via which the tow ball is supported, having a width (W), parallel to a rotational axis (R) extending centrally through the tow ball and perpendicular to a central axis (C) of the tow ball that extends top-to-bottom therethrough, sufficient that the neck passes through the opening, and a length (L) sufficient to permit relative displacement between the neck and assembly and thus relative rotation between the tow ball and the assembly or device about said rotational axis.

According to a second aspect of the present invention, there is provided a ball coupling device (1) comprising a socket assembly (10), configured to assume an operative condition in which it defines a socket to capture a tow ball (100) such that there is formed a sliding fit, permitting relative rotation, between the tow ball and socket or assembly, and to assume an inoperative condition whereby the tow ball and assembly can be decoupled, the assembly being configured so as to be, in the operative condition, engageable with the tow ball at a region between an equator (E) of the tow ball and a neck (104) via which the tow ball is supported, precluding relative translation between the assembly and tow ball along a central axis (C) such that they cannot be decoupled, and so as to be, in the inoperative condition, not engageable with the tow ball at said region, permitting said relative translation such that movement of the device or assembly relative to the tow ball, to separate the former from the latter, along the central axis is unobstructed by the device.

In a preferred embodiment, a ball coupling device (1) according to the second aspect being the device of the first aspect.

Preferably, the socket assembly comprises at least one member or element (3) (“member/element”) adapted to engage in said operative condition a respective one of convex portions (102) of a tow ball (100) arranged about said central axis (C).

According to a third aspect of the present invention, there is provided a ball coupling device (1) comprising members or elements (3) shaped to define concavities (5) complementary in profile to respective convex portions (102) of a tow ball (100) arranged about a central axis (C) of the tow ball and extending top-to-bottom therethrough, the members or elements (“members/elements”) being adapted to assume an operative condition in which the concavities are arranged to engage said portions whereby the tow ball is captured thereby such that there is formed a sliding fit, permitting relative rotation about the central axis, between the members/elements and tow ball, and to assume an inoperative condition whereby the tow ball and the members/elements or device can be decoupled, wherein the members/elements are configured to define in the operative condition an opening (2), disposed about a neck (104) via which the tow ball is supported, having a width (W), parallel to a rotational axis (R) extending centrally through the tow ball and perpendicular to said central axis, sufficient that the neck passes therethrough, and a length (L) sufficient to permit relative displacement between the neck and members/elements therealong and thus relative rotation between the tow ball and the members/elements or device about the rotational axis.

According to a fourth aspect of the present invention, there is provided a ball coupling device (1) comprising members or elements (3) shaped to define concavities (5) complementary in profile to respective convex portions (102) of a tow ball (100) arranged about a central axis (C) extending perpendicular to an equator (E) of the tow ball, the members or elements (“members/elements”) being adapted to assume an operative condition in which the concavities are arranged to engage said portions whereby the tow ball is captured thereby such that there is formed a sliding fit, permitting relative rotation about the central axis, between the tow ball and the members/elements and, and to assume an inoperative condition whereby the tow ball and the members/elements or device can be decoupled, wherein the members/elements are configured so as to be, in the operative condition, engageable with the tow ball at a region between an equator (E) of the tow ball and a neck (104) via which the tow ball is supported, precluding relative translation between the assembly and tow ball along the central axis such that they cannot be decoupled, and so as to be, in the inoperative condition, not engageable with the tow ball at said region, permitting said relative translation such that movement of the device or members/elements relative to the tow ball, to separate the former from the latter, along the central axis is unobstructed by the device.

In a preferred embodiment of the invention, the device according to the second aspect or the fourth aspect, wherein the assembly or at least one member/element is configured to define in the operative condition an opening (2), disposed about the neck (104) and having a width (W), parallel to a rotational axis (R) extending centrally through the tow ball and perpendicular to the central axis (C), sufficient that the neck passes through the opening, and a length (L) sufficient to permit relative displacement between the neck and said assembly or at least one member/element and thus relative rotation between the tow ball and the device or the assembly or at least one member/element about said rotational axis.

In a preferred embodiment of the invention, a ball coupling device according to any one of aspects one to four of the invention, being the device of any one of the other aspects of the invention.

Preferably, said assembly or at least one member/element is configured such that lengthways extension of an/the opening (2) disposed about the neck (104) is circumferential about said rotational axis.

Preferably, peripheral portions (4) of the assembly or at least one member/element arranged to define an/the opening (2) disposed about the neck (104) are profiled to extend circumferentially about said rotational axis (R) when the operative condition is assumed.

Preferably, said assembly or at least one member/element comprises members/elements defining clasp members or elements.

Preferably, the assembly or at least one member/element comprises or defines jaws.

Preferably, the assembly or at least one member/element comprises opposed members or elements.

Preferably, the assembly or at least one member/element defines either end of an/the opening (2) disposed about the neck (104) a stopper (6) arranged to abut the tow ball or neck to preclude continued relative displacement between the tow ball or neck and the device or the assembly or member(s)/element(s).

Preferably, the assembly or at least one member/element comprises a projection (6A) arranged to extend widthways relative to an/the opening (2) disposed about the neck (104) to define a said stopper.

Preferably, the device is configured whereby the width of an/the opening (2) disposed about the neck (104) is such that the neck is abutted slidably by the assembly or at least one member/element to preclude relative rotation, between the tow ball and the assembly or the device or the members/elements, about an axis (A) perpendicular to the central and rotational axes.

Preferably, the assembly or at least one member/element comprises a member/element that is moveable, to assume the inoperative and operative conditions.

Preferably, at least one member/element is pivotally moveable.

Preferably, at least one member/element is arranged to pivot about an upper end (7) thereof.

Preferably, the assembly or at least one member/element comprises members/elements arranged such that lower ends (9) thereof are spaced apart sufficiently that the members/elements are downwardly introduceable over the tow ball in the inoperative condition.

Preferably, the socket assembly comprises a support (11) and at least one member/element mounted to the support to be moveable relative thereto, to assume said operative and inoperative conditions; and/or the device comprises a support (11) to which said at least one member/element is mounted to be moveable relative thereto, to assume the operative and inoperative conditions.

Preferably, the support comprises a body portion (13) shaped to define a concave seat (15) complementary in profile to a convex exterior of a middle portion (106) of the tow ball which is between convex portions thereof, said seat being arranged to lie closely adjacent said middle portion to form a sliding fit with the tow ball permitting the relative rotation about each axis.

Preferably, at least one member/element is mounted to said support to be pivotable about a pivot axis (P1) whereby the operative and inoperative conditions are assumed.

Preferably, members/elements are mounted to said support to be pivotable about a common pivot axis (P1).

Preferably, the assembly or member(s)/element(s) comprise(s) or define(s) clasp portions (17), in which are formed concavities complementary in profile to respective convex portions (102) of the tow ball (100) and arranged to engage said portions when the operative condition is assumed, and arm portions (19) extending so as to be parallel with said rotational axis (R) when the operative condition is assumed, and wherein distal ends (19A) of the arm portions are connected to the clasp portions and proximal ends (19B) of the arm portions are moveably coupled to the support.

Preferably, the support comprises at least one mounting portion (21) projecting from a body portion (13) thereof, to which said proximal ends are moveably coupled.

Preferably, the support comprises plural said mounting portions (21) arranged at spaced positions in a direction parallel to a pivot axis (P1) of the/each member/element and the arm portions are arranged between and pivotally coupled to adjacent ones of said mounting portions.

Preferably, the mounting portions define lugs and each arm portion is pivotally mounted via a shaft or pin (23) extending through each of the adjacent mounting portions between which it is arranged.

Preferably, the members/elements are moveably coupled to the support via interconnections at a side (25) of the support or body portion opposite to a side (27) of the support or body portion arranged to be received adjacent the tow ball.

Preferably, the support comprises a body portion (13) arranged to be abutted, or lain closely adjacent to, on opposite sides (13A) thereof by elements/members to maintain a spacing between the clasp portions (17) in the operative condition.

Preferably, the assembly or at least one member/element comprises clasp or wall portions (17) in which are formed concavities complementary in profile to respective convex portions (102) of the tow ball (100) arranged to engage said convex portions when in the operative condition, the device being configured to define, when the members/elements are in the operative condition, an enclosure to enclose the tow ball, the enclosure comprising said clasp or wall portions.

Preferably, the clasp or wall portions comprise side wall portions (17A) and the concavities comprise side concavities (5A) which open through inner faces of said side wall portions arranged to lie in opposed relation in the operative condition.

Preferably, the wall portions comprise end wall portions (17B) which extend transverse to the side wall portions (17A), and the concavities comprise end concavities which open through inner faces of the end wall portions.

Preferably, the or each members/elements comprise a said stopper defined by at least one said end wall portion.

Preferably, a mounting structure (29) via which it is securable to load to be towed, such as a trailer, caravan or other vehicle, wherein the assembly or at least one member/element is rotatable relative to the mounting structure about an axis of rotation (A) perpendicular to said central and rotational axes.

Preferably, the assembly or at least one member/element is coupled to the mounting structure via a support (11), to which one or more members/elements are moveably mounted, the support being supported from the mounting structure such that it is rotatable relative thereto about said axis of rotation (A).

Preferably, the device includes a shaft (31) to which the support is connected and which is rotatably mounted to said mounting structure.

Preferably, the device includes a single piece defining said shaft and support.

Preferably, the shaft and support are integrally formed.

Preferably, said rotational axis is a laterally extending axis.

Preferably, said assembly or at least one member/element is resiliently biased towards said inoperative condition.

Preferably, each member/element is resiliently biased towards said inoperative condition.

Preferably, the or each member/element is resiliently biased by a biasing component.

Preferably, a said biasing component is arranged to act between said members/elements to resiliently bias them towards said inoperative condition.

Preferably, the at least one biasing component has a laterally inner portion housed within the support and laterally outer portions arranged to engage respective ones of said members/elements.

According to a fifth aspect of the present invention, there is provided a ball coupling device comprising a socket assembly (10) configured to assume an operative condition in which the socket assembly defines a socket configured to capture a tow ball such that there is formed a sliding fit, permitting relative rotation, between the tow ball and socket or assembly, and an inoperative condition whereby the tow ball is not captured by the assembly, the device further comprising a cover (40) moveable between an operative position in which it covers said assembly in the operative condition, and an inoperative position permitting the socket assembly to assume the inoperative condition.

According to a sixth aspect of the present invention, there is provided a ball coupling device comprising at least one member or element (3) (“member/element”) configured to assume an operative condition in which the member(s)/element(s) is/are arranged to lie closely adjacent said tow ball whereby the tow ball is captured by the device and there is formed a sliding fit, permitting relative rotation, between the tow ball and member(s)/element(s), and an inoperative condition which is such that the tow ball is not captured by the assembly, the device further comprising a cover (40) moveable between an operative position, in which it covers said member(s)/element(s) in the operative condition, and an inoperative position whereby the member(s)/element(s) is/are permitted to move such that the inoperative condition is assumed.

In a preferred embodiment of the invention, the device includes a support (11) to which the one or more members/elements are mounted to be moveable relative thereto whereby the operative and inoperative conditions are assumed.

Preferably, the support comprises a body portion (13) shaped to define a concave seat (15) complementary in profile to a convex exterior of a portion of the tow ball, said seat being arranged to lie closely adjacent said portion of the tow ball to form a sliding fit therewith.

Preferably, the cover is mounted to the support so as to be moveable relative thereto whereby the operative and inoperative positions are assumed.

Preferably, the cover is pivotally mounted to the support so as to be pivotable between the operative and inoperative positions.

In a preferred embodiment, a device according to the fifth aspect of the invention, wherein the socket assembly comprises one being the device of according to the sixth aspect of the invention, where in the socket assembly comprises said one or more elements/members.

Preferably, the socket assembly includes said body portion (13).

In a preferred embodiment of the invention, a device according to the sixth aspect of the invention, being the device of any of the first to fifth aspects, wherein the members/elements comprise said coupling members/elements.

Preferably, the cover comprises a housing (41) arranged so as to house the element(s)/member(s) or the assembly in the operative condition.

Preferably, the housing is configured so as in the operative position to house said support.

Preferably, the cover is configured such that in the operative position it engages or abuts, the assembly or at least one element/member to retain the element(s)/member(s)/socket in the operative condition.

Preferably, the cover includes at least one formation or protuberance (42) supported from or defined by the housing and arranged to abut the assembly or at least one said element/member to retain the assembly or element(s)/member(s) in the operative condition.

Preferably, the cover includes a handle (44) for moving it between said positions.

Preferably, the cover is pivotable between the operative and inoperative positions.

According to a seventh aspect of the present invention, there is provided a ball coupling device comprising a socket assembly (10) configured to assume an operative condition, in which the socket assembly defines a socket configured to capture a tow ball such that there is formed a sliding fit, permitting relative rotation, between the tow ball and socket/assembly, and an inoperative condition which is such that the tow ball is not captured by the assembly, the device including at least one retainer (40) placeable into an engaged condition in which the at least one retainer holds the socket assembly in the operative condition, and a disengaged condition permitting the socket assembly to assume the inoperative condition.

According to an eighth aspect of the present invention, there is provided a ball coupling device comprising at least one member or element (3) (“member/element”) configured to assume an operative condition, in which the one or more elements/members are arranged to lie closely adjacent said tow ball whereby the tow ball is captured by the device and there is formed a sliding fit, permitting relative rotation, between the tow ball and member(s)/element(s), and an inoperative condition, which is such that the tow ball is not captured by the member(s)/element(s), the device including at least one retainer (40) placeable into an engaged condition in which the at least one retainer holds the member(s)/element(s) in the operative condition, and a disengaged condition permitting the member(s)/element(s) to assume the inoperative condition.

In a preferred embodiment, the device includes a support (11) to from which the retainer(s) is/are supported so as to be pivotable relative thereto between the operative and inoperative conditions.

Preferably, the support comprises a body portion (13) shaped to define a concave seat (15) complementary in profile to a convex exterior of a portion of the tow ball, said seat being arranged to lie closely adjacent said portion of the tow ball to form a sliding fit therewith.

Preferably, the retainer(s) is/are supported from the support so as to be moveable relative thereto to assume the operative and inoperative conditions.

Preferably, the retainer(s) is/are supported from the support so as to be pivotable between the operative and inoperative conditions.

Preferably, the device includes a locking mechanism (50) operable to lock the retainer(s) in the engaged condition or the cover in the operative position and releasable so as not to preclude the disengaged condition or inoperative position from being assumed.

Preferably, the device includes a latch (51) moveable between a locking position in which it is arranged to act between the retainer(s) or cover and the assembly or member(s)/element(s), to lock the retainer(s) in the engaged condition or the cover in the operative position, and a released position in which it is arranged not to preclude the retainer(s) from assuming a said disengaged condition or the cover from assuming a said inoperative position.

Preferably, the device includes a portion (11A) engageable by the latch, the engageable portion being interconnected with and/or defined by one of the cover or at least one retainer and the assembly/at least one member/element, wherein the latch is moveably coupled to or supported from the other of the cover or at least one retainer and the assembly/at least one member/element to be moveable, relative to said other, between position in which the latch engages the engageable portion, being said locking position, and a position in which the latch is disengaged from the engageable portion, being said released position.

Preferably, said other of the cover or at least one retainer and the assembly/at least one member/element is said cover or at least one retainer.

Preferably, the latch is coupled either to the cover or at least one retainer or to the assembly/at least one member/element, to be moveable relative thereto between a locking position which is such that the cover or retainer(s) and the assembly or member(s)/element(s) are lockingly interengaged via the latch, and a released position which is such that the cover or retainer(s) and the assembly or member(s)/element(s) are not lockingly interengaged via the latch.

Preferably, the latch is moveably supported from the cover.

Preferably, the device includes a pin (52) via which the latch is pivotally coupled to the cover or retainer(s).

Preferably, the latch is arranged in the housing.

Preferably, the device is configured such that the latch is resiliently biased towards or into said locking position when the engaged condition is assumed by the retainer(s) and/or the operative position is assumed by the cover.

Preferably, the device includes at least one resilient biasing component (60) arranged to urge the latch towards or into said locking position when the engaged condition is assumed by the retainer(s) and/or the operative position is assumed by the cover.

Preferably, at least one said resilient biasing component comprises a spring.

Preferably, the latch is arranged to engage a support (11) to which the at least one member/element is mounted, or which the assembly comprises and to which at least one coupling member/element of the assembly is mounted, in the locking position, to lock the retainer(s) in the engaged condition or the cover in the operative position.

Preferably, said engageable portion (11A) is defined by said support.

Preferably, the at least one biasing component is arranged to act between the cover or retainer(s) and the latch.

Preferably, the at least one biasing component is mounted between, or to either or each of, the cover and the latch.

Preferably, the device includes a latch component (55) moveable between a locking position in which an operative portion (55A) thereof is arranged to act between the latch and the cover, to hold the latch in the locking position, and a released position in which the operative portion is arranged not to act between the latch and the cover, so as not to hold the latch in the locking position.

Preferably, the latch component is supported from the latch and moveable relative thereto to be operated.

Preferably, the latch component is rotatably moveable to be operated.

Preferably, the latch component comprises a lever (54A) projecting from the operative portion and manually engageable to operate the latch component.

Preferably, the lever or latch component is arranged so as to be accessible through the cover to be operable such that the latch component moves from said locking position to said released position and/or so as to be accessible exterior to the cover to be operable such that the latch component moves from said released position to said locking position.

Preferably, the cover is configured with an opening (45) through which the lever or latch component is accessible.

Preferably, said operative portion is arranged to lie between a portion (40A) of the cover and the latch to chock the latch in the locking position thereof.

Preferably, said latch is pivotable, about a pivot axis (P2), between the locking and released positions thereof, and the latch component is arranged such that:

the operative portion (55A) lies between the portion of the cover (40A) and a first portion (51A) of the latch, which portion is disposed to one side of a plane (PL) on which the pivot axis lies so as to be displaced in a direction towards said portion of the cover to permit said latch to pivot to its released position, when the latch component is in the locking position thereof; and

the operative portion is adjacent a second portion (51B) of the latch, which portion is disposed to the other side of the plane such that it is displaced in an opposite direction and/or in a direction away from said portion of the cover as said latch pivots to its released position, when the latch component is in the released position thereof.

Preferably, the latch component is rotatable between the locking and released positions thereof.

Preferably, the device includes a stop (56A) arranged to abut the latch component in the locking position thereof to preclude movement thereof beyond the locking position and/or to abut the latch component in the released position thereof to preclude movement thereof beyond the released position.

Preferably, the latch component is biased towards or into the locking position thereof.

Preferably, a centre of mass of the latch component is offset from a rotational axis (Ro), about which the latch component is rotatable between said positions thereof, whereby the latch component is gravitationally biased towards or into the locking position thereof.

Preferably, the device includes a mechanism (70) operable to displace the latch into a said released position.

Preferably, the device includes a mechanism (70) operable to hold the latch in a said released position.

In a preferred embodiment, the device includes a mechanism operable to hold the latch in the said released position upon displacement of the latch from the locking position towards the released position and/or displacement of the retainer(s)/cover from the engaged condition/operative position towards the disengaged condition/inoperative position.

Preferably, the mechanism comprises a member arranged to abut slidably a face of the latch when the retainer(s) and/or cover is/are moved from the engaged condition and/or operative position, towards a said disengaged condition and/or inoperative position.

Preferably, the device includes a fulcrum, wherein said member comprises a lever arranged to be supported by the fulcrum and pivotally coupled to the cover and/or to the retainer(s), the lever (71) including an operative portion (71A) arranged to abut the latch, such that during movement of the retainer(s) and/or cover from the engaged condition and/or operative position, towards a said disengaged condition and/or inoperative position, the lever pivots relative to the retainer(s) and/or cover and about the fulcrum such that the operative portion moves into contact with the latch to assume a position in which it holds the latch in the said released position.

Preferably, the fulcrum is defined by or supported from a/the support, to which the cover is moveably or pivotally mounted and/or from which the retainer(s) is/are moveably or pivotally supported.

Preferably, the lever (71) comprises a proximal portion arranged to be supported by the fulcrum.

Preferably, a portion of the lever distal of said proximal portion is pivotally coupled to the cover and/or retainer(s).

Preferably, the operative portion of the lever is distal of said proximal portion.

Preferably, the operative portion is distal of the lever portion that is pivotally coupled.

Preferably, the device is configured such that the proximal portion is biased against the fulcrum during movement of the cover and/or retainer(s) in a direction from the operative position/engaged condition to the inoperative position/disengaged condition.

In a preferred embodiment, the device includes an element (56) fitted to the latch, and comprising:
a key portion (56B) projecting from the latch into a radially outwardly opening void (52A) formed in a pin (52) via which the latch is rotatably mounted, precluding relative translation between the latch and pin along an axis of the pin, so as to retain the pin and latch together; and
a stop portion (56A), projecting from the latch to define said stop.

Preferably, the pin is configured with a radially outwardly opening circumferential groove defining said void.

Preferably, the element is fitted in or through a hole through the latch.

Preferably, the element and pin are engaged rotationally slidably or rotationally fixedly relative to the pin axis.

Preferably, the latch component comprises a periphery or edge (55B) configured to abut the stop to preclude said movement of the latch component beyond the locking position.

The latch component may comprise a periphery or edge (55B) configured to abut the stop to preclude said movement of the latch component beyond the released position.

In a preferred embodiment, the device includes a mounting structure (29), via which the device is securable to a load to be towed, such as a trailer, caravan or other vehicle, and a shaft (31) rotatably mounted to the mounting structure, via which the assembly or the at least one member or element is supported from the mounting structure such that there is permitted relative rotation between the mounting structure and the assembly or the at least one member or element about an axis of rotation (A) perpendicular to said central and rotational axes.

Preferably, the support structure comprises a housing (29), and the shaft is rotatably supported in the housing.

Preferably, the device further includes a fastening component (32) to secure rotatably to the support structure an end of the shaft that projects from the support structure.

Preferably, the fastening component and support structure are arranged in abutting relation such that the shaft is retained axially relative to the support structure.

Preferably, the device includes an intermediate element (33) arranged between the fastening component and housing such that the support structure and fastening component abut indirectly.

Preferably, the intermediate element comprises a washer.

Preferably, wherein said end and the fastening component have mating threads (31A, 32A) via which they are interconnected.

Preferably, the device includes a retaining device (80) to retain together the shaft and fastening component, the retaining device comprising first (81) and second (82) elements, wherein the first element is formed with a thread (81A) mating with a thread (31A) of the shaft to connect the first element or retaining device to the shaft, and wherein the first and second elements are configured with mating threads such that the/each second element is translationally displaced relative to the first element so as to be in abutment with the fastening component, whereby the fastening component and the/each second element, and/or the mating threads of the shaft and fastening component, are urged into tight engagement to preclude relative rotation between the shaft and fastening component tending to loosen the fastening component.

According to a ninth aspect of the present invention, there is provided a device (80) for retaining together components (31, 32) that are interconnected via mating threads (31A, 32A), the device comprising first (81) and second (82) elements configured with mating threads such that the/each second element is rotatable to be translationally displaced relative to the first element, wherein the first element is formed with a thread (81A) mateable with a thread (31A) of one (31) of the components to connect the first element/device to that component whereby the/each second element can be rotated and thus translationally displaced into abutment with the other (32) component, whereby the said other component and the/each second element, and/or the mating threads of the components, are urged into tight engagement to preclude relative rotation, tending to loosen the interconnection, between the components.

Preferably, the device is for use as the retaining device in a device according to the eighth aspect, whereby the shaft defines said one component and the fastening component defines said other component.

Preferably, the thread with which said first element is formed is internal such that the thread of said one component with which it mates is an external thread of that component.

Preferably, said first element is annular.

Preferably, said first element comprises a nut or collar.

Preferably, the first element comprises a body (81B) arranged to abut the said other component, and wherein the said threads with which the first and second elements are configured are internal to the body and external respectively, so as to mate within the body.

Preferably, the or each second element comprises a screw.

Preferably, the or each screw is headless or comprises a grub screw.

Preferably, the or each screw is configured at a trailing end thereof with a formation, such as a (e.g. hexagonal) socket or a groove, engageable by a driving tool so as to be driveable by the tool.

Preferably, the first element is formed with a said thread (to mate with a said thread of said shaft or one component) which is not concentric with the threads with which the first and second elements are configured.

Preferably, the device comprises plural second elements spaced around the body.

Preferably, the second elements are received or receivable by the body at diametrically opposite positions.

Preferably, at least one said second element comprises a portion arranged to form an indentation or depression in a surface abutted thereby, whereby there is formed a mechanical interlock, comprising the indentation or depression and the said portion received thereby, resisting relative rotation tending to loosen the fastening component.

Preferably, the indentation- or depression-forming portion is defined by a tip of the second element.

Preferably, the tip is cupped and/or hardened.

### BRIEF DESCRIPTION OF THE FIGURES

The present invention will now be described, by way of non-limiting example only, with reference to the accompanying drawings, briefly described as follows.

FIG. 1 shows an assembled ball coupling device according to a preferred embodiment of the invention and a tow ball.

FIG. 2A is a front upper perspective view of the ball coupling device and tow ball, with a cover of the former transparently shaded.

FIG. 2B is a rear upper perspective view of the ball coupling device and tow ball shown in FIG. 2A.

FIG. 3 is an exploded view of the ball coupling device and tow ball.

FIG. 4A is a front upper perspective view of the cover.

FIG. 4B is a rear perspective view of the cover.

FIG. 4C is a front perspective view of an alternative cover.

FIG. 5A is a front perspective view of the tow ball and a socket assembly of the ball coupling device.

FIG. 5B shows particular components of the arrangement shown in FIG. 5A.

FIG. 6A shows a pair of coupling or clasping members of the socket assembly.

FIGS. 6B and 6C are a front view and bottom view, respectively, of the coupling members.

FIGS. 7A and 7B are an angled perspective view and side view, respectively, of one of the coupling/clasping members.

FIG. 8 shows a support member which forms part of the arrangement shown in FIG. 5A.

FIG. 9 is an exploded view showing details of a locking mechanism of the ball coupling device.

FIG. 10 is a perspective view of a latch of the ball coupling device.

FIG. 11 is a perspective view showing a detent mechanism of the ball coupling device.

FIG. 12 is a section view showing details of the locking assembly.

FIG. 13 shows a locking arrangement for retaining a rotational interlock between an end of a shaft of the support member and a housing via which the device is mounted to a towed vehicle.

FIG. 14A is a front upper perspective view of the housing.

FIG. 14B is a rear upper perspective view of the housing.

FIG. 15A shows a top view of a support fastened to a mounting/housing.

FIG. 15B shows a section view along the line A-A of the components shown in FIG. 15A.

FIGS. 16A and 16B show side and front views of the ball coupling device in an inoperative state with a tow ball.

### DETAILED DESCRIPTION

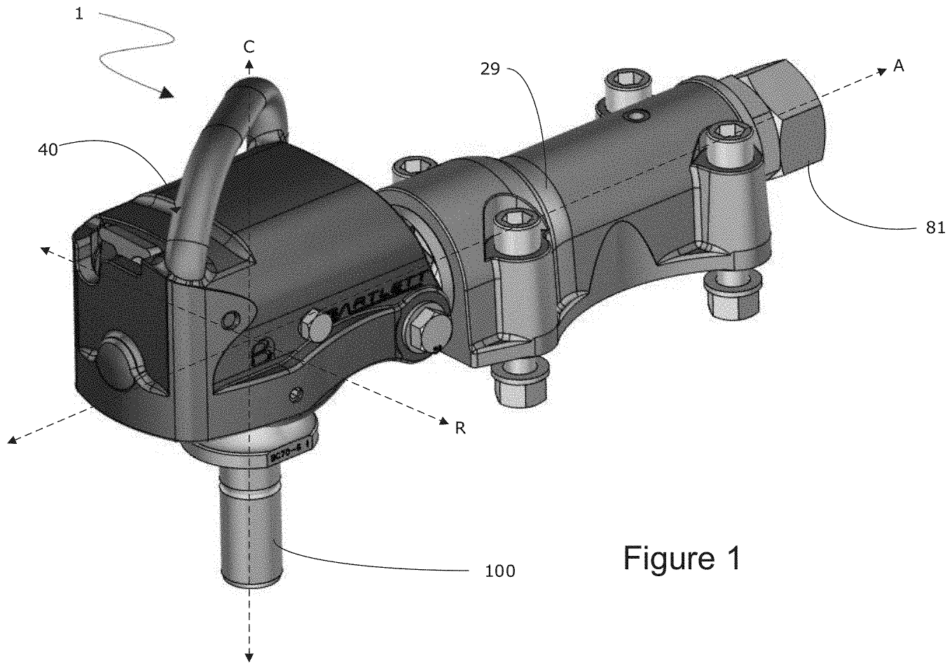

Illustrated in FIG. 1 is a ball coupling device (1) for coupling a towing vehicle (not shown) to a towed vehicle (not shown), such as a trailer, caravan or other load to be towed. In use, a tow ball (100) is engaged with the ball coupling device (1), so as to allow three axes of articulation (C, R, A) between the vehicles. The central axis (C) extends top-to-bottom through the tow ball (100). The other two axes (R, A) are perpendicular to one another and to the central axis (C), as shown in FIG. 1, and rotate with the coupling device about the axis C.

Having three axes of rotational articulation allows the vehicles, coupled via the ball (100) and device (1), to negotiate turns and uneven road more easily, because each vehicle can rotate independent of the other. For example, if the two vehicles are to travel across a dip, the towing vehicle can travel down the dip and rotate in a pitching direction to start ascending, while the towed vehicle may continue pitching downwards. In off-road applications, this articulation can help ensure that all road wheels maintain contact with the ground where it is uneven.

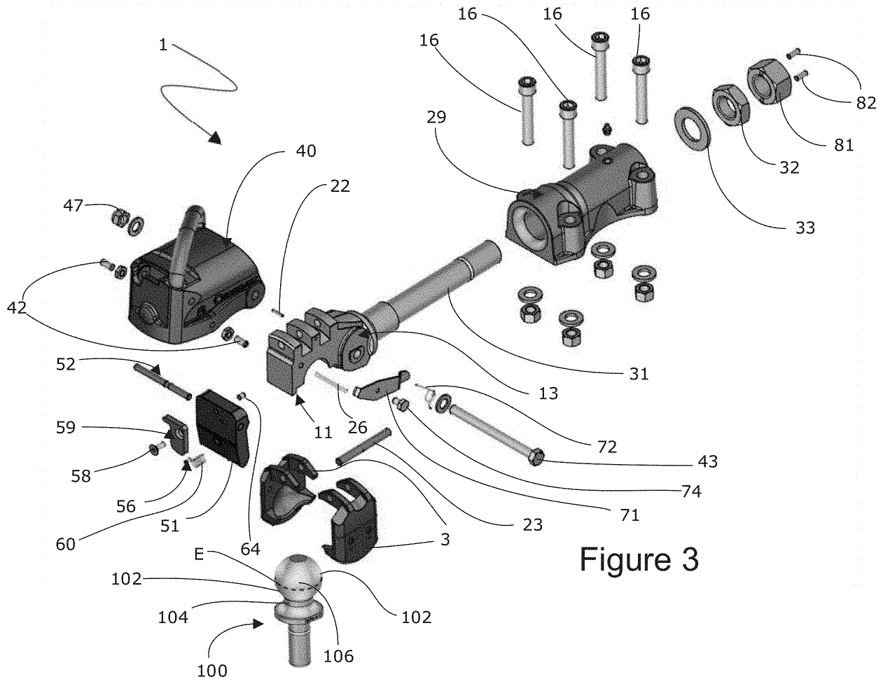

FIG. 3 provides an exploded assembly view of the ball coupling device (1) and tow ball (100). The tow ball (100) in the example illustrated has a diameter of 70 mm, which is a size of tow ball commonly attached to road vehicles. However, a person skilled in the art will understand that the ball coupling device (1) may be adapted for use with other sizes of tow ball, including a 50 mm tow ball, 2-inch tow ball, 2 5/16-inch tow ball and a 3-inch tow ball. The tow ball (100) has and equator (E), laterally opposed convex portions (102), and a middle portion (106) which is between the portions (102) and perpendicular to the equator (E), the exterior of which extends circumferentially. The tow ball (100) is supported by a neck (104). The tow ball (100) is attached to a road vehicle below the neck (104). The neck (104) is of reduced diameter in comparison to the diameter of the spherical portion of the tow ball (100).

The ball coupling device (1) comprises coupling members (3) and a main member (14) including a shaft section (31) and a support (11), connected to the shaft section (31), from which the members (3) are supported, whereby there is defined a socket assembly, comprising or defined by the support (11) and members (3), engageable with the tow ball (1), as will be described further below. The device (1) further comprises a cover (40), pivotally mounted to the body portion (13), which in a closed condition protectively shields the socket assembly and (when the device (1) is engaged with the tow ball (100)) precludes that assembly from becoming decoupled from the tow ball (100), and a housing structure (29) from which the member (14)—specifically, the shaft (31)—is supported to be rotatable about axis A, and which is securable to the towed vehicle via mounting bolts (16) to mount the device (1) to that vehicle, the housing structure (29) thus defining a mount or mounting structure of the device (1).

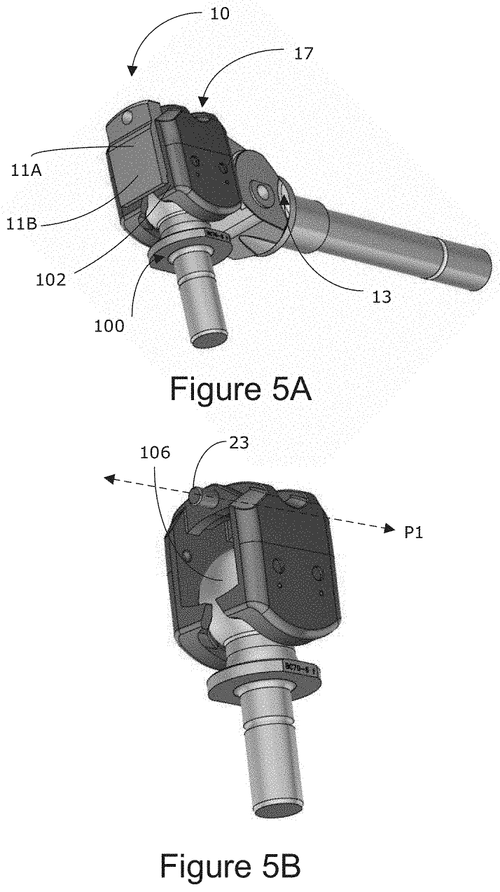

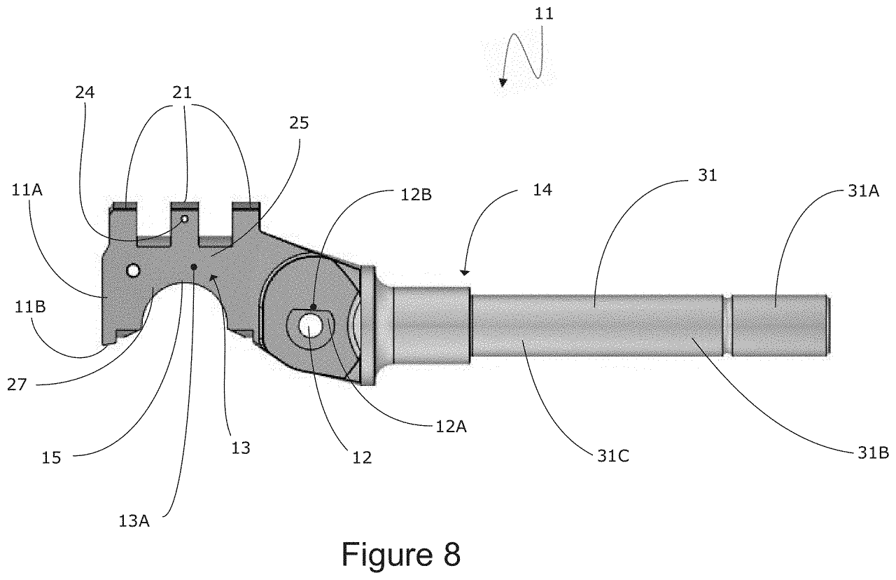

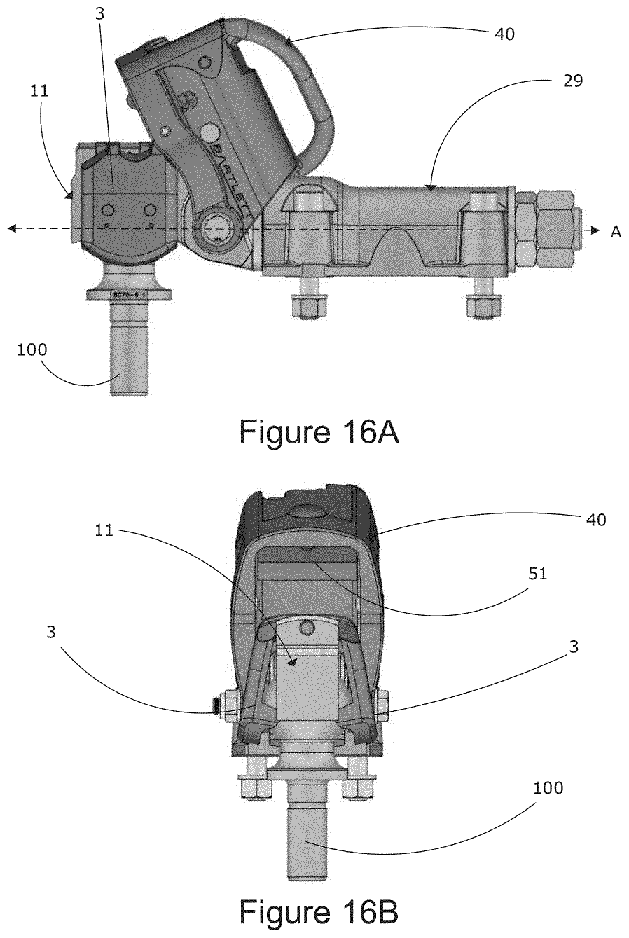

Referring in particular to FIGS. 5A to 7B, the coupling members (3) comprise clasping members (17) mounted to a body portion (13) of the support (11) to be pivotable relative thereto between operative (shown in FIGS. 1 to 3) and inoperative conditions (shown in FIGS. 16A and 16B). More particularly, each of the members (3)/(17) comprises at an upper end (7) thereof arms (19) spaced apart along an axis (P1), each having a proximal end portion (19A) and a distal end portion (19B), the former portion being configured with a hole (20) through which passes a pivot pin (23) that is additionally received by (holes in) lugs (21), best seen at FIG. 8, which project from an upper side (27) of the body portion (13) and are likewise spaced apart along the axis (P1), such that the proximal end portion (19A) is pivotally connected to the support (11)/body portion (13) whereby the member (3)/(17) is pivotable about the axis (P1), the lugs (21) thus defining mounting portions. The mounting portions (21) form a castellated structure on the body portion (13), and the arms (19) are arranged between and pivotally coupled to adjacent ones of the mounting portions (21). The clasping members (17) may additionally be biased toward the inoperative condition by a compression spring (26).

A transverse pin (22) is received within a hole (24) a transverse hole passing through a said lug (21) and a corresponding such hole passing through the pin (23), to locate and lock the pin (23) axially.

The clasping members (17) comprise clasp or wall portions which are supported from the distal end portions (19B) of the arms in which concavities (5) are formed. More particularly, clasping members (17) are shaped to define side wall portions (17A) and end wall portions (17B), and the concavities (5) comprise side concavities (5A), which open through inner faces of said side wall portions (17A) arranged to lie in opposed relation when the members (17) are in their operative condition, and end concavities (5B) which open through upper/inner faces of the end wall portions (17B). Each of the concavities (5) is complementary in profile to a respective one of the tow ball convex portions (102), so as to form a close sliding fit therewith.

The body portion (13) is shaped to define, on a lower side (25) thereof, a concave seat (15) complementary in profile to, and arranged to lie closely adjacent the convex exterior of the middle portion (106) of the tow ball so as to form a sliding fit therewith. The socket assembly, which includes the concavities (5) and seat (15), thus defines, when the members (3)/(17) are in the operative condition, an enclosure to enclose the tow ball (100), the enclosure comprising concave bearing surfaces, defined by the concavities (5) and seat (15), which conform to a sphere.

Opposed lateral sides (13A) of the body portion (13) are arranged to be abutted by the members (3)/(17), when those members assume the operative condition.

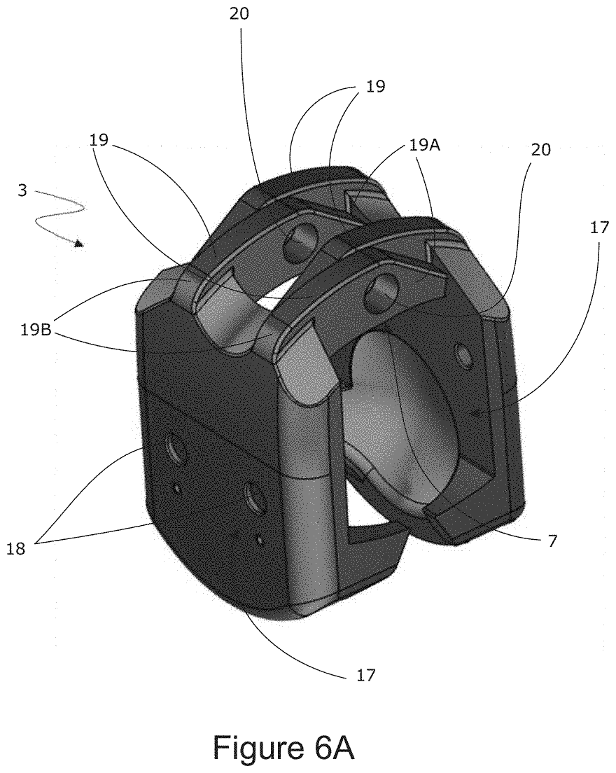

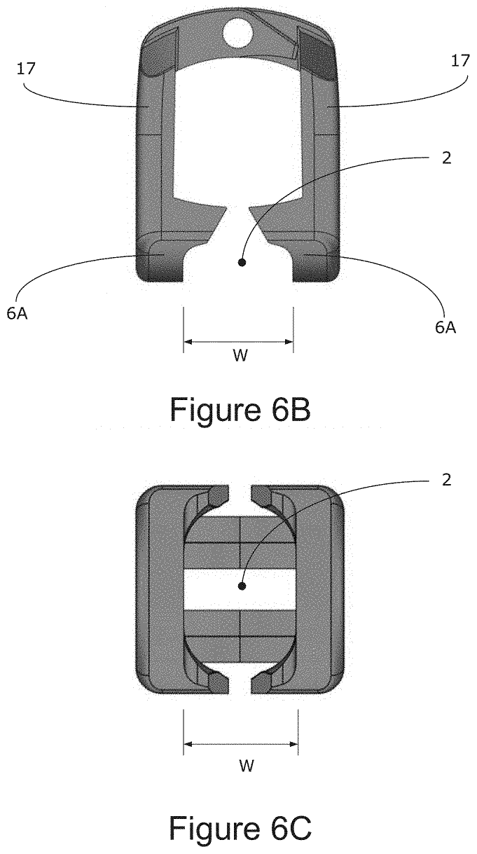

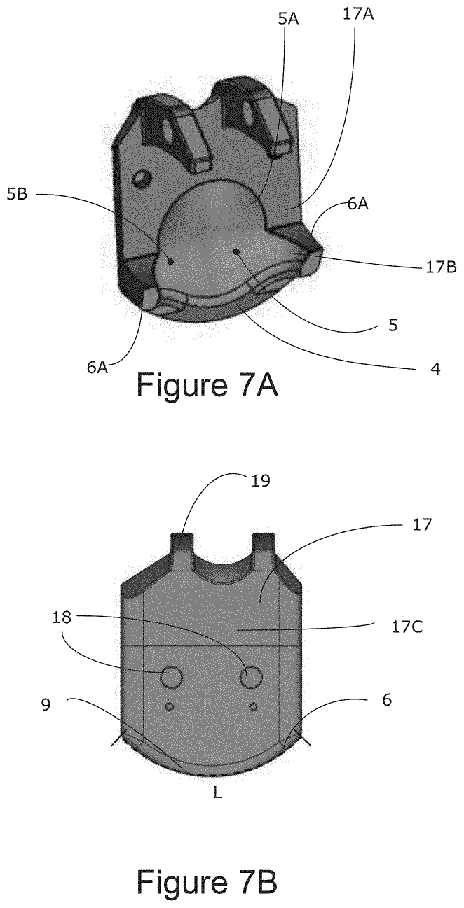

The members (3)/(17) are thus adapted to assume an operative and inoperative condition, whereby the tow ball (100) may be slidingly captured by those members/the device (1) and be released therefrom or introduced thereto respectively. In the inoperative condition, lower ends (9) of the members (3)/(17) are spaced sufficiently to permit those members to be downwardly introducible over the tow ball (100). When the members (3)/(17) assume the operative condition to engage the tow ball (100), the wall portions/concavities (5) thereof are received against/adjacent both the upper hemisphere and the lower hemisphere of the ball to each side of a plane in which the/an equator (E) thereof lies, as will be apparent from FIGS. 6A and 7A, whereby the ball is trapped between the members (17). As can best be seen from FIG. 7A, the end walls (17B) or concavities (5B) receive or engage a hemisphere portion of the ball adjacent the neck (104) whereas the side walls (17A) or concavities (5A) receive or engage the other (opposite) hemisphere portion of the ball.

However, in the example shown, as can also best be seen from FIG. 7A, the inner face of each side wall portion (17A) is configured so as to extend beyond the equator about which those hemispheres are arranged, whereby the periphery of the part-circular opening through that face subtends an angle greater than 180 degrees, such that there are defined bearing portions (8) which (together with the end concavities (5B)) engage the hemisphere on the neck side, with the result that part of loading exerted on the members (3) by the ball in a direction towards the neck (104) is taken through those bearing portions. In other embodiments, the said inner face may be configured so as not to extend beyond the equator whereby the said angle subtended does not exceed 180 degrees.

With the tow ball (100) thus slidingly captured by the device (1) (when in the operative condition), a substantial degree of rotation of the coupling device (1) relative to the tow ball (100) is, owing to the design of the former (discussed further below), permitted. In particular, in the present example, rotation through around 30 degrees in either rotational direction about axis (R) from a central position is possible.

It can thus be seen that the coupling members (3) are arranged to engage the convex portions (102) of the tow ball (100) when in the operative condition and so as not to engage the convex portions (102) (whereby the tow ball (100) is not captured by them) when in the inoperative condition. In the present embodiment, there are two clasping members or jaws (17); however, the number of these may vary without departure from the invention.

The members (3)/(17) are shaped such that when they assume the operative condition there is defined between them an opening (2) arranged to be disposed about the neck (104) of the tow ball when captured thereby. The opening (2) has a (maximum) width dimension (W), which is parallel to the rotational axis (R), and length dimension (L), which is tangential to that axis. The length (L) is sufficient to permit relative displacement between the neck (104) and members (3)/(17), and thus relative rotation between the tow ball (100) and members (3)/(17) about the rotational (R), in either direction (along the length (L)) from the aforementioned central position. This rotation may be caused by a change in pitch of the towing vehicle relative to the towed vehicle. The lower ends (9) of the members (3)/(17) define stops or stoppers (6) at opposite ends of the opening (2) (along dimension (L)), the stops or stoppers (6) being arranged to abut the neck (104) or neck region to preclude continued relative displacement between it and the members (3)/(17) or device (1) about the axis (R), and comprising projections (6A) formed at the lower ends (9) and arranged to extend widthways relative to the opening (2).

The width of the opening (2) is such that the members (3)/(17) abut the neck (104) or neck region slidably to preclude relative rotation between the tow ball (100) and members (3)/(17) about an axis (A) perpendicular to the central (C) and rotational axes (R).

The width (W) is sufficient to permit relative rotation between the ball/neck (104) and device (1) or members (3)/(17) about the axis (C), though is closely matched to the diameter of the neck 104/neck region about which the opening (2) is disposed, such that each lower end (9) can form a sliding fit with the neck 104/neck region, allowing relative rotation between the tow ball (100) and device (1) or members (3)/(17) about a central axis (C) (the extent of which rotation is not limited by the members (3)/(17) of themselves) but precluding relative rotation between the tow ball (100) and the members (3)/(17) about an axis (A).

The opening (2) is thus circumferentially elongate (along dimension (L)) about the rotational axis (R) and thus, advantageously, enables the extent of the relative rotation about that axis to be significant. The elongation of the opening (2) may be viewed as a scalloping of the lower end (9) of the clasping members (17) as seen in the side-on view presented in in FIG. 7A. Thus, the opening (2) has a non-circular plan form as seen in the bottom view presented in FIG. 7B.

The clasping members (17) are identical in shape and configuration, such that they may be used interchangeably on either side of the ball coupling device (100).

As previously described, the housing/mounting structure (29) can be secured, by means of bolts (16), to the towed vehicle, such that it is mounted to that vehicle. The housing/mounting structure (29) thus mounted is rotatable relative to the shaft (31) about an axis (A), which is coaxial with the central axis of the shaft (31).

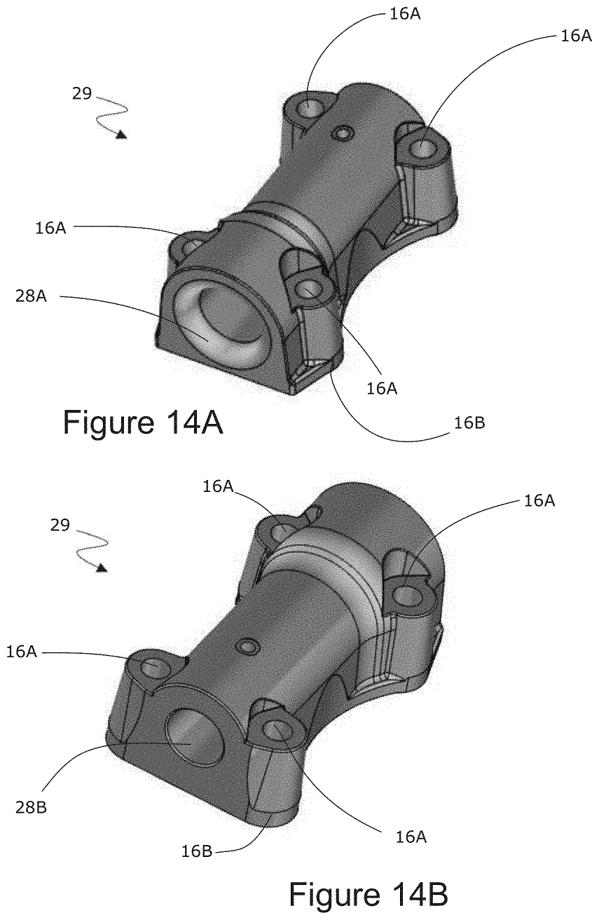

Referring to FIGS. 3, 14A and 14B, the member (14) may be introduced into the housing structure (29) via a mounting section (28A) at a first end of the housing (29) until it projects from a mounting section (28B) at a second end of the housing (29) opposite the first end. Each mounting section (28A, 28B) defines a bore to receive a respective one of opposed end portions (31C) and (31B) of the shaft (31) and dimensioned to form a rotationally sliding fit with those portions, thereby mounting the shaft (31).

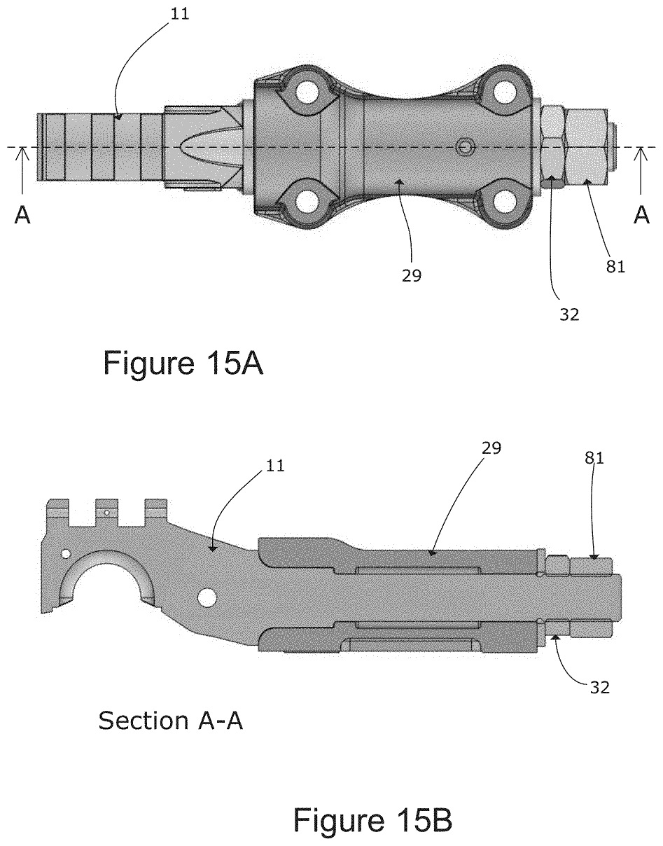

The housing (29) further comprises through-holes (16) through which mounting bolts (16) are receivable to secure the housing (29) to the towed vehicle as previously indicated. In addition, the housing (29) has a grease port (30) to which a grease nipple (90) is fitted. The grease nipple is in fluid communication with the chamber (30A), as seen in FIG. 15B.

The shaft (31), referring additionally to FIG. 8, has a shoulder (14A) arranged to abut the mounting section (28A) to locate and retain the shaft axially relative to the mounting structure (29) in a first direction.

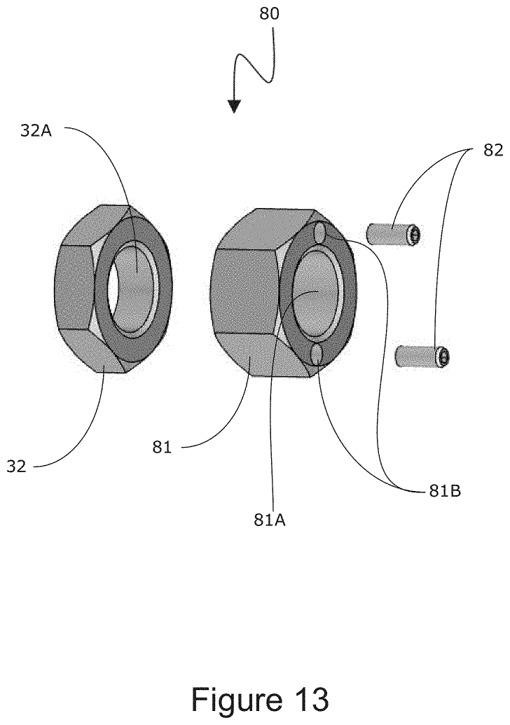

Referring to FIGS. 1 and 13, the free end of the shaft (31), which projects from the mounting structure (29), is retained against axial movement relative to the mounting structure (29) in a direction towards the shaft fixed end by a fastening component, defined by a nut (32), secured to the free end and arranged in abutting relation with the mounting section (28B). The shaft (31) and nut (32) have respective mating threads (31A, 32A) via which they are interconnected. Between the nut (32) and mounting structure (29) is a washer (33), whereby the mounting structure (29) and nut (32) abut indirectly.

A retaining device (80) is provided to retain together the shaft (31) and nut (32). The retaining device (80) comprises first (81) and second (82) elements. The first element (80) is formed with a thread (81A) for mating with thread (31A) of the shaft (31) to connect the first element to the shaft (31). The first element (81) is annular and is defined by a nut (32). The body of the nut (81) is arranged to abut the nut (32). The nut (81) is further configured with other internal threads (81B) formed in apertures in the body of the nut (81) not concentric with thread (81A).

The retaining device (80) further comprises second elements (82) which are screws. Each screw (82) is headless and defines a grub screw. Furthermore, each screw (82) is configured at a trailing end of that screw (82) with a formation for engaging with a driving tool. The formation is a hexagonal socket in the example shown but may, without departure from the invention, instead comprise another female formation (such as, for example, at least one groove), or a male formation, as is known in the art, engageable by a driving tool so as to be driveable by the tool. Each screw (82) has an external thread, which is configured to mate with internal threads (81B) in the body of the nut (81). Furthermore, each screw has a tip, and is translationally displaced through the nut (81) such that the tip abuts the nut (32), whereby the nut (32) and each screw (82), and mating thread of the shaft (31) and nut (32), are urged into tight engagement to preclude relative rotation between the shaft (31) and nut (32) tending to loosen the nut (32). Because each screw (82) abuts the nut (32) at a position eccentric to the axis of rotation of the nut (32), it imparts friction to the nut (32) at that position. Moreover, each tip may form an indentation or depression in the surface of the nut that it abuts, and may to that end be hardened and cupped, whereby there is defined a mechanical interlock comprising the indentation or depression and the tip therein. The friction and/or interlock, owing to its/their being eccentric to the rotational axis of the nut (32), impart(s) to that nut a reactive torque opposing any torque on the nut (32) tending to unscrew/loosen it.

The retaining device can be used generally for retaining components that are to be interconnected. The device (80) in the example shown has two set screws (82) received in the body of the nut (81) at diametrically opposite positions. However, it is contemplated that a single set screw (82) or three or more set screws (82) may instead, with an appropriately configured first element (81), be employed.

In the illustrated embodiment, the cover (40) is pivotably mounted to the support (11) to be movable between an operative and inoperative condition. The cover (40) comprises a housing (41) to shield the support (11) and house the socket assembly (10) when in the operative condition, and a handle (44) for moving the cover (40) between the operative and inoperative conditions.

The cover (40) is pivotally mounted to the support (11) by means of a bolt (43), passed through mounting holes (46) in opposite side walls of the cover and a corresponding mounting hole (12) extending through the support (11) therebetween, the bolt (43) being fastened in place by a nut (47) received over its leading end on the outside of the cover (40). The cover (40) is substantially cuboid and has an open lower face, permitting downward pivoting receipt of the cover (40) over the socket assembly (10) and support (11). The cover (40) may have an open end face, through which a (relatively robust) forward portion of the support (11) not prone to damage is exposed and may project when the cover (40) is closed (whereby the open end face allows for the cover (40) to be placed into its operative condition.

In the operative condition, the cover (40) retains the clasping members (17) in the operative condition and covers the socket assembly (10). The cover (40) is provided with retainers (42) which are configured to hold the socket assembly (10) in an engaged condition by abutting the socket assembly (10). Each retainer (42) comprises a grub screw or bolt received in a threaded mounting hole in a respective side wall of the cover (40), so as to pass through the side wall whereby it is arranged such that when the cover (40) is in the operative condition, a leading end or tip of the screw or bolt abuts an outer wall (17C) of a respective one of the clasping members (17). In the engaged condition, the retainers (42) hold the coupling members in the operative condition.

The retainer further has a disengaged condition in which it does not abut the socket assembly. When the cover is in the inoperative condition, it permits the socket assembly (10) to assume the inoperative condition. Furthermore, when the ball coupling device (1) is in this condition, the cover (40) may be biased away from assuming the operative condition by engagement with the clasping members (17), which are in turn biased towards the inoperative condition by compression spring (26).

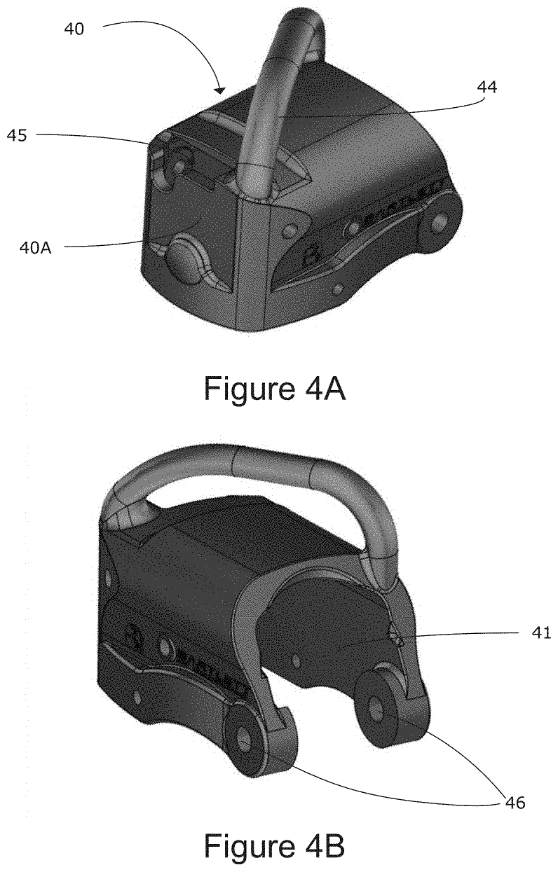

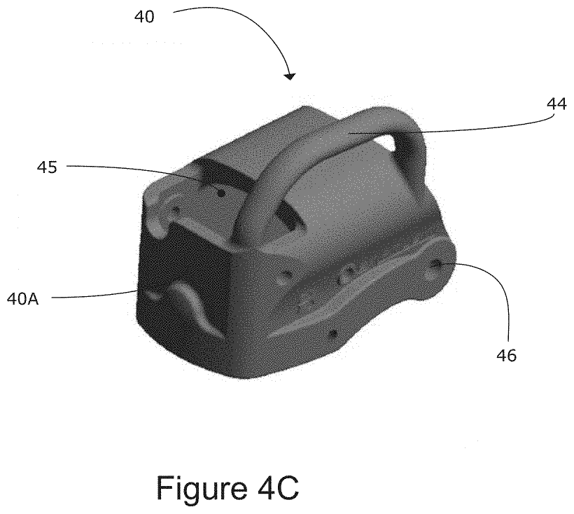

FIG. 4C shown an alternative cover (40) arrangement in which the handle (44) is parallel to a side of the cover (40).

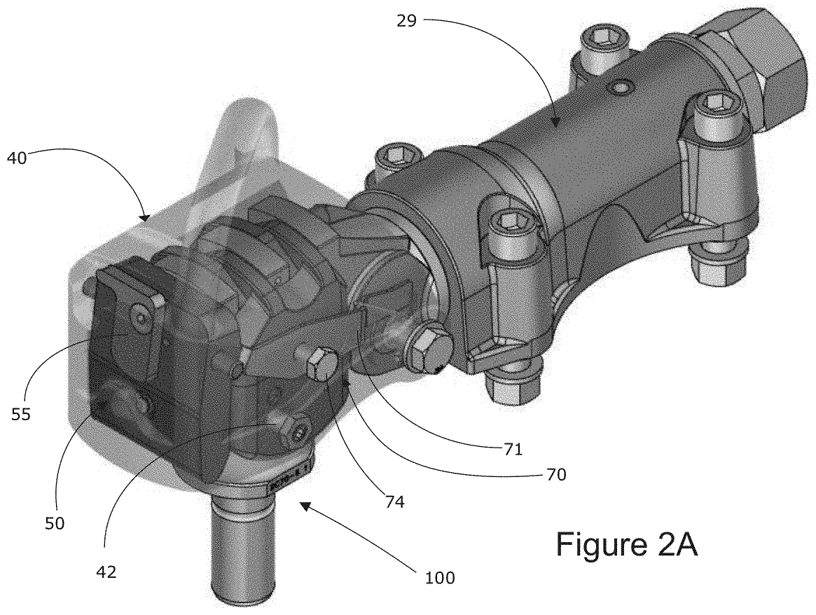

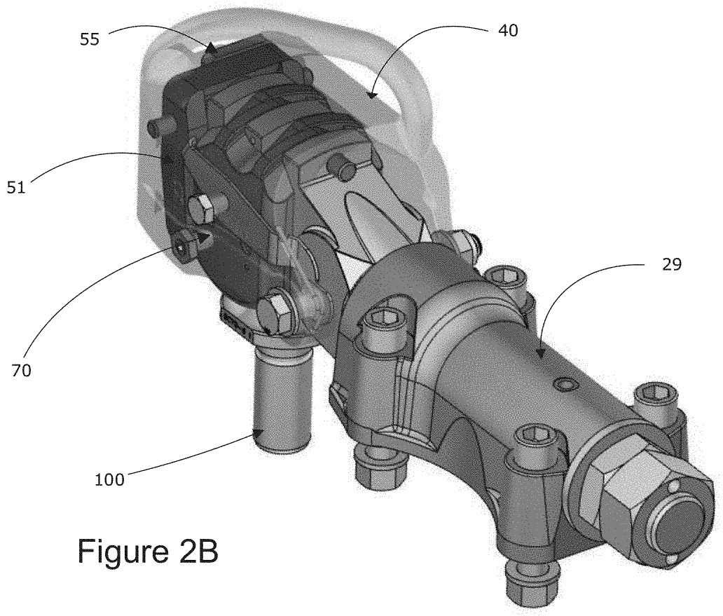

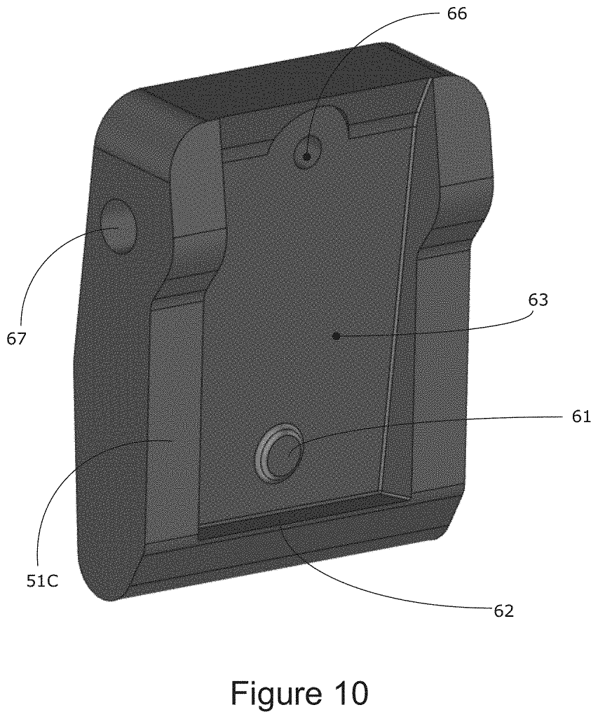

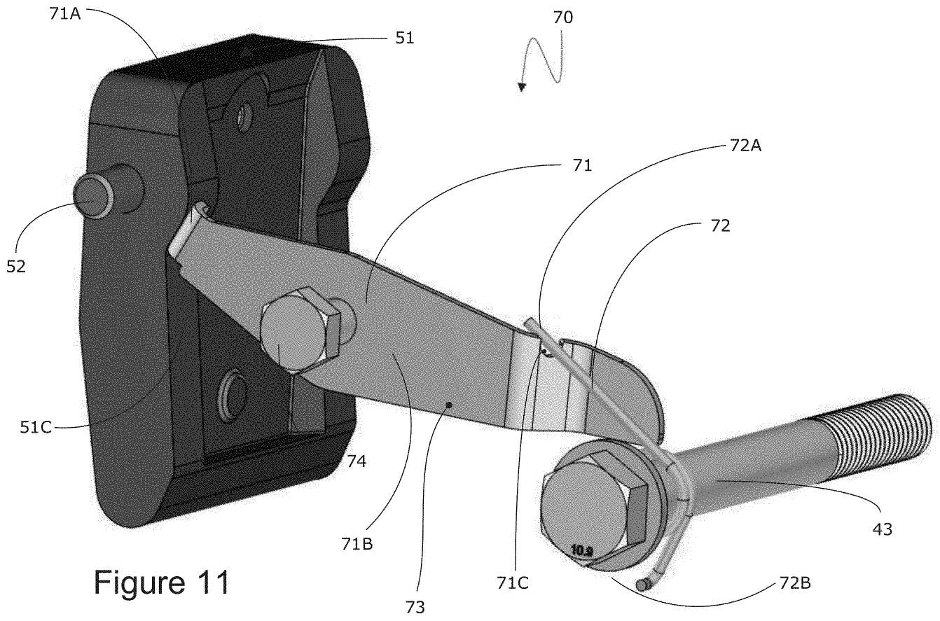

The ball coupling device (1), referring to FIG. 2A, further comprises a locking mechanism (50) operable to lock the cover (40) in the operative condition and releasable to permit the inoperative condition to be assumed by the cover (40). Referring also to FIGS. 5A, 8 and 9 to 12, the locking mechanism (50) comprises a latch (51) and a pivot pin (52) which extends through mounting holes in opposed side walls of the cover (40) and a corresponding mounting hole (67) passing through a proximal portion of the latch (51), whereby the latch (51) is interconnected with the cover (40) within the housing (41) to be rotatably movable, about a pivot axis (P2) defined by pin (52), between a locking position and a released position. Opposed end portions of the pin (52) are received in opposed side walls of the cover (40). In the locking position, the latch (51) engages with a portion (11A) of the support (11) to prevent movement of the cover (40) from the operative condition to the inoperative condition. In the locking position, the engageable portion (11A) is received in a recess (63) formed in the latch (51), shown in FIG. 10. The lower region of the recess (63) is bounded by a lip or step (62), which is received against a lower edge (11B) of the engageable portion (11A), precluding said movement of the cover. A first portion (51A) of the latch, of which portion the lip or step (62) forms a part, lies below a generally level or horizontal plane (PL) on which the axis (P2) lies.

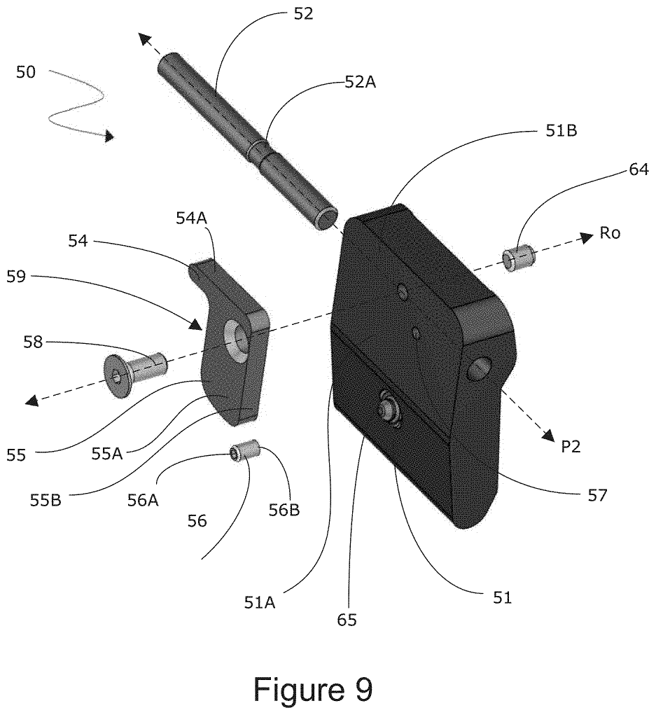

The latch (51) is able to be pivoted about the axis (Pp2) by another latch (55) (“latch component” or “secondary latch”), shown at FIG. 2A, whereby a first portion (51A) of the latch (51) is drawn towards the cover front wall (40A), against a resilient bias offered by a spring (60) (also discussed later below). As the latch (51) pivots about the axis (P2) to the released position (clockwise as viewed from the perspective of FIG. 9), the first portion of the latch (51) moves towards a front wall (40A) of the cover (40) and the lip or step (62) is disengaged from the engageable portion edge (11B). A second portion (51B) of the latch (51), which lies above the plane (PL), simultaneously moves away from the front wall (40A). The latch (51), once the lip or step (62) is clear of the engageable portion (11A), does not preclude movement of the cover (40) from the operative condition towards the inoperative condition.

In the inoperative condition, the latch (51) is resiliently biased towards the engaged condition by biasing spring (60), which can be seen in FIG. 3. The biasing spring (60) acts between the latch (51) and front wall (40A) of the housing (40), whereby movement of the latch (51) from the locking position to the released position is against the bias. The spring (60) is mounted to the latch (51) by means of a seat (65). In alternative examples, the spring (60) may, without departure from the invention, be located in other locations to bias the latch (51). When the latch (51) assumes the locking position, a protrusion (61) formed in the latch (51), which extends into the recess (63), abuts a surface of the engageable portion (11A)/support (11).

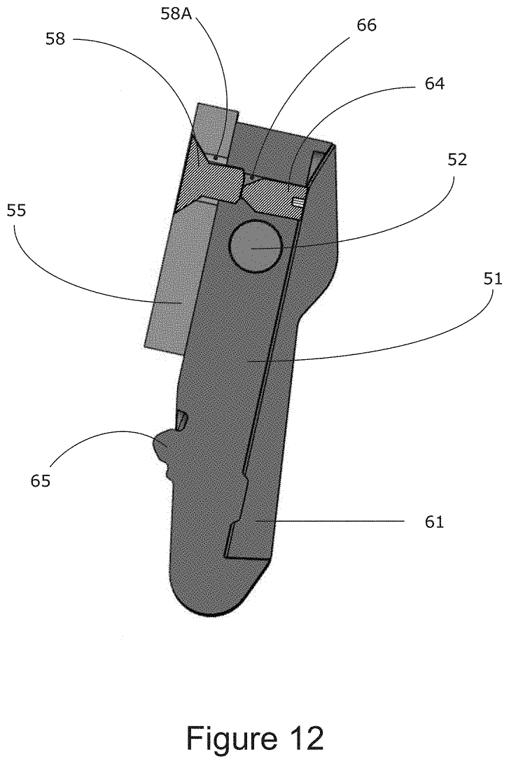

The device (1) or locking mechanism (50) also includes, referring to FIGS. 1, 9 and 12, latch component or secondary latch (55), and a screw (58) received through a mounting hole in the secondary latch and into a threaded mounting hole (58A) in the second portion (51B) of latch (51), thus rotatably mounting the secondary latch (55), the head of the screw (58) being countersunk in the secondary latch (55). The secondary latch (55) is rotatable, about the screw (58), between a locking position, shown at FIGS. 2 and 12, and a released position. When the secondary latch (55) is in the locking position, an operative part (55A) thereof is arranged between the first portion (51A) of the latch (51) and the cover front wall (40A) to hold the latch (51) in the locking position. More particularly, the operative portion (55A) is chocked between cover wall portion (40A) and the first portion (51) of the latch (51) to hold the latch (51) in the locking position.

The secondary latch (55) includes a tab or lever (54) which is, referring to FIG. 1, accessible through an opening (45) in the housing (41) whereby it can be pushed to rotate the latch (55) (through 90 degrees about rotation axis Ro in the example shown) from its locking position to its released position, in which the operative part (55A) is positioned adjacent the second portion (51B) of the latch (51), i.e. does not project into the space between the first portion (51A) of latch (51) and front wall portion (40A), whereby movement of the latch (51) to the released position is permitted. Furthermore, tab or lever (54) of the secondary latch (55) may be urged to rotate about the pivot axis (P2) to urge the latch (51) to rotate about the pivot axis (P2) from the locking position to the released position.

The locking mechanism (50) or device (1) further comprises an element (56) having a stop portion (56A) and a key portion (56B). A mounting hole (57) is provided in the latch (51) to receive the element (56) therethrough, such that the element (56) is mounted to the latch (51). When the element (56) is so mounted, the stop portion (56A) projects from a front surface of the latch (51) whereby, referring also to FIG. 15, a side surface portion thereof abuts an edge (55B) of the body/operative part (55A) when the secondary latch (55) is in its locking position, precluding it from continued rotation beyond that position, and an upper surface portion thereof abuts the edge (55B) when the secondary latch (55) is in its released position, precluding it from continued rotation beyond that position. Also, the key portion (56B) projects from the rear side of the latch (51) into a radially outwardly opening circumferential groove (52A) formed on the pin (52), thereby forming a key precluding axial displacement of the pin (52) in the hole (67), so as to retain the pin (52) to the latch (51) and vice versa. The key portion (56B) may engage the pin (52) tightly enough within the groove (52) that the latch (51) is locked to the pin (52) rotationally about the axis (P2), so that pivoting of the latch (51) about that axis involves rotation of the pin (52).

The hole (57) may be provided with a thread, in which case the element (56) is provided with a mating thread between the portions (56A) and (56B) so as to be secured in the hole (57). Alternatively, the hole (57) may have a diameter slightly smaller than that of the portion of the element (56) which is received therein, such that there is formed an interference fit between that portion/the element (56) and the latch (51).

The secondary latch (55), including the lever (54) thereof, defines a trigger (59). Owing to the shape of the body/operative portion (55A), and the position of the mounting hole in the secondary latch (55), the centre of gravity of the secondary latch (55) is eccentric to the rotational axis of the latch (55), whereby the body/operative portion (55A) defines a counterweight which gravitationally biases the secondary latch (55)/trigger (59) towards its locking position.

Referring to FIGS. 9 and 12, the locking mechanism 50 may include a grub screw (64) received into a threaded hole (66) formed in the side of the latch opposite to that in which the threaded hole (58A) is formed, one of the holes (58A) and (66) opening into the other. The holes (58A, 66) are not concentric, whereby a tip of the screw (64) abuts the tip of the screw (58) at a position eccentric to the axis of rotation of the screw (58) such that, in addition to urging the threads of the screw (58) and hole (58A) into tight engagement, it imparts friction to the screw (58) at that position. In some examples, the holes (58A, 66) are not co-axial and are axially displaced, not in parallel alignment or both. The tip of screw (64) may form an indentation or depression in the surface of the tip of screw (58), and may to that end be hardened and cupped, whereby there is defined a mechanical interlock comprising the indentation or depression and the tip therein. The friction and/or interlock, owing to its/their being eccentric to the rotational axis of the screw (58), impart(s) to that screw a reactive torque opposing any torque on the screw (58) tending to unscrew/loosen it.

The ball coupling device (1) further comprises, referring to FIGS. 2, 10 and 11, a detent mechanism (70), having a distal portion (71A) and a proximal portion (71B), operable to hold the latch (51) in a released position (opposing the action of the spring 60) when the inoperative position is assumed by the cover (40). The detent mechanism comprises a detent member (71), which is rotatably mounted, at a position intermediate proximal and distal ends thereof, to the cover (40) via a mounting bolt (74) (which is received through a complementarily threaded mounting hole through a side wall of the cover (40)/housing (41)), such that when the cover (40) is in the inoperative condition, a distal portion (71A) of the detent member (71) abuts a first surface (51C) of the latch (51) to hold the latter in a released position, thereby preventing the cover (40) from jamming when it is moved from the inoperative condition towards the operative condition. The detent member (71) is configured to rotate about the bolt (74) as the cover (40) is moved between the inoperative and operative conditions.

The rotation of the detent member (71) is controlled by a stop and a biasing member at a distal end of the detent member (71). In the illustrated embodiment, the stop is defined by a flattened boss (12A) extending from a surface of the support (11) and which approximates a “D” shape. The boss has an upper flat surface (12B), which is shaped to engage the detent member (71). The biasing member is a torsional spring (72), a first portion (72A) of which engages with a slot (71C) in the detent member (71) to resist rotation of the detent member (71) in a direction opposite to the direction in which the boss (12A) resists rotation. A second portion (72B) of the torsional spring (72) is fitted to the cover (40) so that the torsional spring (72) may rotate with the cover (40). In the engaged position, an edge (73) of the detent member (71) is parallel with the flat surface (12B) of the boss (12A). As the cover (40) is moved to the inoperative condition, the edge (73) of the detent member (71) rotates about the boss (12A).

As the cover (40) moves to the operative condition, the action of a spring (72) of the mechanism (70) (described further below) and the movement of the latch (51) causes the retreat of a distal portion (71A) of the detent member (71) from the first surface (51C) of the latch (51) allowing spring (60) to move latch (51) toward the locking position. When the cover (40) is in the operative condition, the detent member (71) is clear of any part of the latch (51). The reverse occurs when the ball coupling device (1) assumes the operative condition from the inoperative condition. As previously described, when the ball coupling device (1) is in the operative condition, the secondary latch (55) prevents the latch from assuming the released position. Furthermore when the ball coupling device (1) is in the inoperative condition, the detent member (71) is clear of the latch (51). For the ball coupling device (1) to assume the inoperative condition from the operative condition, the secondary latch (55) must first be rotated to the released position, whereby the operative part (55A) of the secondary latch (55) is not positioned between the first portion (51A) of the latch and the front wall portion (40A) of the cover. The tab or lever (54) of the trigger (59) is then urged to rotate about the pivot axis (P2) to urge the latch (51) to rotate about the pivot axis (P2) from the locking position to the disengaged position. The cover (40) is then able to be moved from the operative condition to the inoperative condition. As the cover (40) is moved from the operative condition to the inoperative condition, a distal portion (71A) of the detent member engages the first surface (51C) of the latch (51) to hold the latch (51) in its released position.

There are situations in which displacement of the cover (40) to the inoperative condition (following release of the locking mechanism (50)) may be dangerous. One such situation is where there is an unbalanced load on a trailer to which the ball coupling device (1) is attached, which load may induce rotation of the trailer in a manner tending to separate the ball coupling device (1) from the tow ball (100) when the trailer is no longer secured to the towing vehicle. Therefore, if the locking mechanism (50) is operated while the trailer is in such a condition, the ball coupling device (1) may separate suddenly from the ball once the latch (51) is released, potentially causing injury or damage.

To prevent such separation, a safety mechanism is provided in the ball coupling device (1). The safety mechanism comprises cooperating features on each of the coupling members (3) and cover (40). If the locking mechanism (50) is operated when there is a substantial force on the coupling members (3) to move them to the inoperative condition, the cooperating features act to prevent the coupling members (3) from assuming the inoperative condition. However, the cooperating features do not act to prevent the coupling members (3) from assuming the inoperative condition if the only force on the coupling members (3) to move them to the inoperative condition is due to the compression spring (26).

Specifically, the cooperating features prevent the coupling members (3) from assuming their inoperative condition by preventing the cover (40) from assuming its inoperative condition.

More particularly, the cooperating features comprise recesses (18) formed in the clasping members (17) and protrusions (42) extending from the cover (40). The protrusions are defined by grub screws (42). As an alternative to a grub screw, a bolt may be used. When the cover (40) is in the operative condition, the grub screws (42) engage with an outer wall (17C) of the clasping members (17). If the cover (40) moves from the operative condition while there is a load on the clasping members (17) to move them to the inoperative condition, as the cover (40) moves, the grub screws (42) will be received the recesses (18). Once the grub screws (42) are received in the recesses (18), the cover (40) will be precluded from moving further until the load is removed and the clasping members (17) assume the operative condition.

In order to install the ball coupling device (1), the mount (29) is fastened to the trailing vehicle. The ball coupling device (1) may be raised on a dolly wheel of the trailing vehicle or by any other appropriate means, such that the socket assembly (10) is situated above the tow ball (100). The cover (40) is then maintained in the inoperative condition, while the ball coupling device (1) is downwardly introduced over the tow ball (100) so that the convex portions (102) of the tow ball (100) are received in the socket assembly (10). Once the tow ball (100) has been engaged completely by the socket assembly (10), the cover (40) may be brought to the operative condition, thereby securing the clasping members (17) in the operative condition. The trigger (59) may then be actuated to the locking position if it has not already assumed that position.

To release the tow ball (100), the reverse operation is conducted. The actuator is moved to the released position, and then the latch (51) brought to the inoperative condition. The cover (40) may then be moved to the inoperative condition provided there is no significant outward load on the coupling members (3).

The ball coupling device (1), advantageously, complies with standards including Australian Standards AS4177 and AS3819.1-1998, while being useable on a wider range of terrain.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

### Statements Relating to Invention or Embodiments Thereof

The invention or preferred embodiments thereof may be defined by any of the following numbered statements.

1. A ball coupling device comprising a socket assembly, configured to assume an operative condition in which it defines a socket to capture a tow ball such that there is formed a sliding fit, permitting relative rotation, between the tow ball and socket or assembly, and to assume an inoperative condition whereby the tow ball and assembly can be decoupled, the assembly being configured to define in the operative condition an opening, disposed about a neck via which the tow ball is supported, having a width, parallel to a rotational axis extending centrally through the tow ball and perpendicular to a central axis of the tow ball that extends top-to-bottom therethrough, sufficient that the neck passes through the opening, and a length sufficient to permit relative displacement between the neck and assembly and thus relative rotation between the tow ball and the assembly or device about said rotational axis.

2. A ball coupling device comprising a socket assembly, configured to assume an operative condition in which it defines a socket to capture a tow ball such that there is formed a sliding fit, permitting relative rotation, between the tow ball and socket or assembly, and to assume an inoperative condition whereby the tow ball and assembly can be decoupled, the assembly being configured so as to be, in the operative condition, engageable with the tow ball at a region between an equator of the tow ball and a neck via which the tow ball is supported, precluding relative translation between the assembly and tow ball along a central axis such that they cannot be decoupled, and so as to be, in the inoperative condition, not engageable with the tow ball at said region, permitting said relative translation such that movement of the device or assembly relative to the tow ball, to separate the former from the latter, along the central axis is unobstructed by the device.

3. A ball coupling device according to statement 2, being the device of statement 1.

4. A ball coupling device according to any one of statements 1 to 3, wherein the socket assembly comprises at least one member or element (“member/element”) adapted to engage in said operative condition a respective one of convex portions of a tow ball arranged about said central axis.

5. A ball coupling device comprising members or elements shaped to define concavities complementary in profile to respective convex portions of a tow ball arranged about a central axis of the tow ball and extending top-to-bottom therethrough, the members or elements (“members/elements”) being adapted to assume an operative condition in which the concavities are arranged to engage said portions whereby the tow ball is captured thereby such that there is formed a sliding fit, permitting relative rotation about the central axis, between the members/elements and tow ball, and to assume an inoperative condition whereby the tow ball and the members/elements or device can be decoupled, wherein the members/elements are configured to define in the operative condition an opening, disposed about a neck via which the tow ball is supported, having a width, parallel to a rotational axis extending centrally through the tow ball and perpendicular to said central axis, sufficient that the neck passes therethrough, and a length sufficient to permit relative displacement between the neck and members/elements therealong and thus relative rotation between the tow ball and the members/elements or device about the rotational axis.

6. A ball coupling device comprising members or elements shaped to define concavities complementary in profile to respective convex portions of a tow ball arranged about a central axis extending perpendicular to an equator of the tow ball, the members or elements (“members/elements”) being adapted to assume an operative condition in which the concavities are arranged to engage said portions whereby the tow ball is captured thereby such that there is formed a sliding fit, permitting relative rotation about the central axis, between the tow ball and the members/elements and, and to assume an inoperative condition whereby the tow ball and the members/elements or device can be decoupled, wherein the members/elements are configured so as to be, in the operative condition, engageable with the tow ball at a region between an equator of the tow ball and a neck via which the tow ball is supported, precluding relative translation between the assembly and tow ball along the central axis such that they cannot be decoupled, and so as to be, in the inoperative condition, not engageable with the tow ball at said region, permitting said relative translation such that movement of the device or members/elements relative to the tow ball, to separate the former from the latter, along the central axis is unobstructed by the device.

7. A ball coupling device according to statement 2, 3 or statement 4 as appended thereto, or to statement 6, wherein the assembly or at least one member/element is configured to define in the operative condition an opening, disposed about the neck and having a width, parallel to a rotational axis extending centrally through the tow ball and perpendicular to the central axis, sufficient that the neck passes through the opening, and a length sufficient to permit relative displacement between the neck and said assembly or at least one member/element and thus relative rotation between the tow ball and the device or the assembly or at least one member/element about said rotational axis.

8. A ball coupling device according to any one of statements 1 to 7, being the device of any of the other of those statements.

9. A device according to any one of the preceding statements, wherein said assembly or at least one member/element is configured such that lengthways extension of an/the opening disposed about the neck is circumferential about said rotational axis.

10. A device according to any one of the preceding statements, wherein peripheral portions of the assembly or at least one member/element arranged to define an/the opening disposed about the neck are profiled to extend circumferentially about said rotational axis when the operative condition is assumed.

11. A device according to any one of the preceding statements, wherein said assembly or at least one member/element comprises members/elements defining clasp members or elements.

12. A device according to any one of the preceding statements, wherein the assembly or at least one member/element comprises or defines jaws.

13. A device according to any one of the preceding statements, wherein the assembly or at least one member/element comprises opposed members or elements.

14. A device according to any one the preceding statements, wherein the assembly or at least one member/element defines either end of an/the opening disposed about the neck a stopper arranged to abut the tow ball or neck to preclude continued relative displacement between the tow ball or neck and the device or the assembly or member(s)/element(s).

15. A device according to statement 14 as appended to statement 13, wherein the assembly or at least one member/element comprises a projection arranged to extend widthways relative to an/the opening disposed about the neck to define a said stopper.

16. A device according to any one of the preceding statements, configured whereby the width of an/the opening disposed about the neck is such that the neck is abutted slidably by the assembly or at least one member/element to preclude relative rotation, between the tow ball and the assembly or the device or the members/elements, about an axis perpendicular to the central and rotational axes.

17. A device according to any one of the preceding statements, wherein the assembly or at least one member/element comprises a member/element that is moveable, to assume the inoperative and operative conditions.

18. A device according to statement 17, wherein at least one member/element is pivotally moveable.

19. A device according to statement 18, wherein at least one member/element is arranged to pivot about an upper end thereof.

20. A device according to any one of the preceding statements, wherein the assembly or at least one member/element comprises members/elements arranged such that lower ends thereof are spaced apart sufficiently that the members/elements are downwardly introduceable over the tow ball in the inoperative condition.

21. A device according to any one of the preceding statements, wherein:

the socket assembly comprises a support and at least one member/element mounted to the support to be moveable relative thereto, to assume said operative and inoperative conditions; and/or the device comprises a support to which said at least one member/element is mounted to be moveable relative thereto, to assume the operative and inoperative conditions.

22. A ball coupling device according to statement 21, wherein the support comprises a body portion shaped to define a concave seat complementary in profile to a convex exterior of a middle portion of the tow ball which is between convex portions thereof, said seat being arranged to lie closely adjacent said middle portion to form a sliding fit with the tow ball permitting the relative rotation about each axis.

23. A device according to statement 21 or 22, wherein at least one member/element is mounted to said support to be pivotable about a pivot axis whereby the operative and inoperative conditions are assumed.

24. A device according to statement 23, wherein members/elements are mounted to said support to be pivotable about a common pivot axis.

25. A device according to any one of statements 21 to 24, wherein the assembly or member(s)/element(s) comprise(s) or define(s) clasp portions, in which are formed concavities complementary in profile to respective convex portions of the tow ball and arranged to engage said portions when the operative condition is assumed, and arm portions extending so as to be parallel with said rotational axis when the operative condition is assumed, and wherein distal ends of the arm portions are connected to the clasp portions and proximal ends of the arm portions are moveably coupled to the support.

26. A device according to statement 25, wherein the support comprises at least one mounting portion projecting from a body portion thereof, to which said proximal ends are moveably coupled.

27. A device according to statement 26, wherein the support comprises plural said mounting portions arranged at spaced positions in a direction parallel to a pivot axis of the/each member/element and the arm portions are arranged between and pivotally coupled to adjacent ones of said mounting portions.

28. A device according to statement 27, wherein the mounting portions define lugs and each arm portion is pivotally mounted via a shaft or pin extending through each of the adjacent mounting portions between which it is arranged.

29. A device according to any one of statements 25 to 28, wherein the members/elements are moveably coupled to the support via interconnections at a side of the support or body portion opposite to a side of the support or body portion arranged to be received adjacent the tow ball.

30. A device according to any one of statements 21 to 29, wherein the support comprises a body portion arranged to be abutted, or lain closely adjacent to, on opposite sides thereof by elements/members to maintain a spacing between the clasp portions in the operative condition.

31. A device according to any one of the preceding statements, wherein the assembly or at least one member/element comprises clasp or wall portions in which are formed concavities complementary in profile to respective convex portions of the tow ball arranged to engage said convex portions when in the operative condition, the device being configured to define, when the members/elements are in the operative condition, an enclosure to enclose the tow ball, the enclosure comprising said clasp or wall portions.

32. A device according to statement 31, wherein the clasp or wall portions comprise side wall portions and the concavities comprise side concavities which open through inner faces of said side wall portions arranged to lie in opposed relation in the operative condition.

33. A device according to statement 32, wherein the wall portions comprise end wall portions which extend transverse to the side wall portions, and the concavities comprise end concavities which open through inner faces of the end wall portions.

34. A device according to statement 14 or 15 and statement 33, wherein the or each members/elements comprise a said stopper defined by at least one said end wall portion.

35. A device according to any one of the preceding statements, comprising a mounting structure via which it is securable to load to be towed, such as a trailer, caravan or other vehicle, wherein the assembly or at least one member/element is rotatable relative to the mounting structure about an axis of rotation perpendicular to said central and rotational axes.

36. A device according to statement 35, wherein the assembly or at least one member/element is coupled to the mounting structure via a support, to which one or more members/elements are moveably mounted, the support being supported from the mounting structure such that it is rotatable relative thereto about said axis of rotation.

37. A device according to statement 36, including a shaft to which the support is connected and which is rotatably mounted to said mounting structure.

38. A device according to statement 37, including a single piece defining said shaft and support.

39. A device according to statement 37 or 38, wherein the shaft and support are integrally formed.

40. A device according to any one of the preceding statements, said rotational axis is a laterally extending axis.

41. A device according to any one of the preceding statements, wherein said assembly or at least one member/element is resiliently biased towards said inoperative condition.

42. A device according to statement 41, wherein each member/element is resiliently biased towards said inoperative condition.

43. A device according to statement 41 or 42, wherein the or each member/element is resiliently biased by a biasing component.

44. A device according to statement 42, wherein at least one said biasing component is arranged to act between said members/elements to resiliently bias them towards said inoperative condition.

45. A device according to statement 43 or 44, wherein the at least one biasing component has a laterally inner portion housed within the support and laterally outer portions arranged to engage respective ones of said members/elements.

46. A ball coupling device comprising a socket assembly configured to assume an operative condition in which the socket assembly defines a socket configured to capture a tow ball such that there is formed a sliding fit, permitting relative rotation, between the tow ball and socket or assembly, and an inoperative condition whereby the tow ball is not captured by the assembly, the device further comprising a cover moveable between an operative position in which it covers said assembly in the operative condition, and an inoperative position permitting the socket assembly to assume the inoperative condition.

47. A ball coupling device comprising at least one member or element (“member/element”) configured to assume an operative condition in which the member(s)/element(s) is/are arranged to lie closely adjacent said tow ball whereby the tow ball is captured by the device and there is formed a sliding fit, permitting relative rotation, between the tow ball and member(s)/element(s), and an inoperative condition which is such that the tow ball is not captured by the assembly, the device further comprising a cover moveable between an operative position, in which it covers said member(s)/element(s) in the operative condition, and an inoperative position whereby the member(s)/element(s) is/are permitted to move such that the inoperative condition is assumed.

48. A device according to statement 47, including a support to which the one or more members/elements are mounted to be moveable relative thereto whereby the operative and inoperative conditions are assumed.

49. A device according to statement 48, wherein the support comprises a body portion shaped to define a concave seat complementary in profile to a convex exterior of a portion of the tow ball, said seat being arranged to lie closely adjacent said portion of the tow ball to form a sliding fit therewith.

50. A ball coupling device according to statement 48 or 49, wherein the cover is mounted to the support so as to be moveable relative thereto whereby the operative and inoperative positions are assumed.

51. A ball coupling device according to statement 50, wherein the cover is pivotally mounted to the support so as to be pivotable between the operative and inoperative positions.

52. A device according to statement 46, being the device of any one of statements 47 to 51, wherein the socket assembly comprises said one or more elements/members.

53. A device according to statements 49 and 52, wherein the socket assembly includes said body portion.

54. A ball coupling device according to any one of statements 47 to 53, being the ball coupling device of any one of statements 1 to 46, wherein said members/elements comprise said coupling members/elements.

55. A ball coupling device according to any one of statements 46 to 54, wherein the cover comprises a housing arranged so as to house the element(s)/member(s) or the assembly in the operative condition.

56. A ball coupling device according to statement 55 and any one of statements 48 to 51, wherein the housing is configured so as in the operative position to house said support.

57. A ball coupling device according to any one of statements 46 to 56, wherein the cover is configured such that in the operative position it engages or abuts, the assembly or at least one element/member to retain the element(s)/member(s)/socket in the operative condition.

58. A ball coupling device according to statement 57 as appended to either one of statements 55 and 56, wherein the cover includes at least one formation or protuberance supported from or defined by the housing and arranged to abut the assembly or at least one said element/member to retain the assembly or element(s)/member(s) in the operative condition.

59. A ball coupling device according to any one of statements 46 to 58, wherein the cover includes a handle for moving it between said positions.

60. A ball coupling device according to any one of statements 46 to 59, wherein the cover is pivotable between the operative and inoperative positions.

61. A ball coupling device comprising a socket assembly configured to assume an operative condition, in which the socket assembly defines a socket configured to capture a tow ball such that there is formed a sliding fit, permitting relative rotation, between the tow ball and socket/assembly, and an inoperative condition which is such that the tow ball is not captured by the assembly, the device including at least one retainer placeable into an engaged condition in which the at least one retainer holds the socket assembly in the operative condition, and a disengaged condition permitting the socket assembly to assume the inoperative condition.

62. A ball coupling device comprising at least one member or element (“member/element”) configured to assume an operative condition, in which the one or more elements/members are arranged to lie closely adjacent said tow ball whereby the tow ball is captured by the device and there is formed a sliding fit, permitting relative rotation, between the tow ball and member(s)/element(s), and an inoperative condition, which is such that the tow ball is not captured by the member(s)/element(s), the device including at least one retainer placeable into an engaged condition in which the at least one retainer holds the member(s)/element(s) in the operative condition, and a disengaged condition permitting the member(s)/element(s) to assume the inoperative condition.

63. A device according to statement 61 or 62, including a support to from which the retainer(s) is/are supported so as to be pivotable relative thereto between the operative and inoperative conditions.

64. A device according to statement 63, wherein the support comprises a body portion shaped to define a concave seat complementary in profile to a convex exterior of a portion of the tow ball, said seat being arranged to lie closely adjacent said portion of the tow ball to form a sliding fit therewith.

65. A device according to statement 63 or 64, wherein the retainer(s) is/are supported from the support so as to be moveable relative thereto to assume the operative and inoperative conditions.

66. A ball coupling device according to statement 65, wherein the retainer(s) is/are supported from the support so as to be pivotable between the operative and inoperative conditions.

67. A ball coupling device according to any one of statements 46 to 66, including a locking mechanism operable to lock the retainer(s) in the engaged condition or the cover in the operative position and releasable so as not to preclude the disengaged condition or inoperative position from being assumed.

68. A ball coupling device according to any one of statements 46 to 67, including a latch moveable between a locking position in which it is arranged to act between the retainer(s) or cover and the assembly or member(s)/element(s), to lock the retainer(s) in the engaged condition or the cover in the operative position, and a released position in which it is arranged not to preclude the retainer(s) from assuming a said disengaged condition or the cover from assuming a said inoperative position.

69. A ball coupling device according to statement 68, including a portion engageable by the latch, the engageable portion being interconnected with and/or defined by one of the cover or at least one retainer and the assembly/at least one member/element, wherein the latch is moveably coupled to or supported from the other of the cover or at least one retainer and the assembly/at least one member/element to be moveable, relative to said other, between position in which the latch engages the engageable portion, being said locking position, and a position in which the latch is disengaged from the engageable portion, being said released position.

70. A ball coupling device according to statement 69, wherein said other of the cover or at least one retainer and the assembly/at least one member/element is said cover or at least one retainer.

71. A ball coupling device according to statement 68, wherein the latch is coupled either to the cover or at least one retainer or to the assembly/at least one member/element, to be moveable relative thereto between a locking position which is such that the cover or retainer(s) and the assembly or member(s)/element(s) are lockingly interengaged via the latch, and a released position which is such that the cover or retainer(s) and the assembly or member(s)/element(s) are not lockingly interengaged via the latch.

72. A ball coupling device according to any one of statements 68 to 71, wherein the latch is moveably supported from the cover.

73. A ball coupling device according to any one of statements 68 to 72, including a pin via which the latch is pivotally coupled to the cover or retainer(s).

74. A ball coupling device according to statement 55 and any one of statements 68 to 73, wherein the latch is arranged in the housing.

75. A ball coupling device according to any one of statements 68 to 74, configured such that the latch is resiliently biased towards or into said locking position when the engaged condition is assumed by the retainer(s) and/or the operative position is assumed by the cover.

76. A ball coupling device according to statement 75, including at least one resilient biasing component arranged to urge the latch towards or into said locking position when the engaged condition is assumed by the retainer(s) and/or the operative position is assumed by the cover.

77. A ball coupling device according to statement 76, wherein at least one said resilient biasing component comprises a spring.

78. A ball coupling device according to any one of statements 68 to 77, wherein the latch is arranged to engage a support to which the at least one member/element is mounted, or which the assembly comprises and to which at least one coupling member/element of the assembly is mounted, in the locking position, to lock the retainer(s) in the engaged condition or the cover in the operative position.

79. A ball coupling device according to statements 69 and 78, wherein said engageable portion is defined by said support.

80. A ball coupling device according to statement 78 or 79 as dependent from statement 61, wherein the at least one biasing component is arranged to act between the cover or retainer(s) and the latch.

81. A ball coupling device according to statement 80, wherein the at least one biasing component is mounted between, or to either or each of, the cover and the latch.

82. A ball coupling device according to any one of statements 68 to 81, including a latch component moveable between a locking position in which an operative portion thereof is arranged to act between the latch and the cover, to hold the latch in the locking position, and a released position in which the operative portion is arranged not to act between the latch and the cover, so as not to hold the latch in the locking position.

83. A ball coupling device according to statement 82, wherein the latch component is supported from the latch and moveable relative thereto to be operated.

84. A ball coupling device according to either one of statements 82 and 83, wherein the latch component is rotatably moveable to be operated.

85. A ball coupling device according to any one of statements 82 to 84, wherein the latch component comprises a lever projecting from the operative portion and manually engageable to operate the latch component.

86. A ball coupling device according to any one of statements 82 to 85, wherein the lever or latch component is arranged so as to be accessible through the cover to be operable such that the latch component moves from said locking position to said released position and/or so as to be accessible exterior to the cover to be operable such that the latch component moves from said released position to said locking position.

87. A ball coupling device according to statement 86, wherein the cover is configured with an opening through which the lever or latch component is accessible.

88. A ball coupling device according to any one of statements 82 to 87, wherein said operative portion is arranged to lie between a portion of the cover and the latch to chock the latch in the locking position thereof.

89. A ball coupling device according to statement 88, wherein said latch is pivotable, about a pivot axis, between the locking and released positions thereof, and the latch component is arranged such that:

the operative portion lies between the portion of the cover and a first portion of the latch, which portion is disposed to one side of a plane on which the pivot axis lies so as to be displaced in a direction towards said portion of the cover to permit said latch to pivot to its released position, when the latch component is in the locking position thereof; and the operative portion is adjacent a second portion of the latch, which portion is disposed to the other side of the plane such that it is displaced in an opposite direction and/or in a direction away from said portion of the cover as said latch pivots to its released position, when the latch component is in the released position thereof.

90. A ball coupling device according to either one of statements 88 and 89, wherein the latch component is rotatable between the locking and released positions thereof.

91. A ball coupling device according to any one of statements 88 to 90, including a stop arranged to abut the latch component in the locking position thereof to preclude movement thereof beyond the locking position and/or to abut the latch component in the released position thereof to preclude movement thereof beyond the released position.

92. A ball coupling device according to statement 91, wherein the latch component is biased towards or into the locking position thereof.

93. A ball coupling device according to statement 92, wherein a centre of mass of the latch component is offset from a rotational axis, about which the latch component is rotatable between said positions thereof, whereby the latch component is gravitationally biased towards or into the locking position thereof.

94. A ball coupling device according to any one of statements 68 to 93, wherein the device includes a mechanism operable to displace the latch into a said released position.

95. A ball coupling device according to any one of statements 68 to 94, wherein the device includes a mechanism operable to hold the latch in a said released position.

96. A ball coupling device according to statement 95, including a mechanism operable to hold the latch in the said released position upon displacement of the latch from the locking position towards the released position and/or displacement of the retainer(s)/cover from the engaged condition/operative position towards the disengaged condition/inoperative position.

97. A ball coupling device according to statement 96, wherein the mechanism comprises a member arranged to abut slidably a face of the latch when the retainer(s) and/or cover is/are moved from the engaged condition and/or operative position, towards a said disengaged condition and/or inoperative position.

98. A ball coupling device according to statement 96 or 97, including a fulcrum, wherein said member comprises a lever arranged to be supported by the fulcrum and pivotally coupled to the cover and/or to the retainer(s), the lever including an operative portion arranged to abut the latch, such that during movement of the retainer(s) and/or cover from the engaged condition and/or operative position, towards a said disengaged condition and/or inoperative position, the lever pivots relative to the retainer(s) and/or cover and about the fulcrum such that the operative portion moves into contact with the latch to assume a position in which it holds the latch in the said released position.

99. A ball coupling device according to statement 98, wherein the fulcrum is defined by or supported from a/the support, to which the cover is moveably or pivotally mounted and/or from which the retainer(s) is/are moveably or pivotally supported.

100. A ball coupling device according to statement 98 or 99, wherein the lever comprises a proximal portion arranged to be supported by the fulcrum.

101. A ball coupling device according to statement 100, wherein a portion of the lever distal of said proximal portion is pivotally coupled to the cover and/or retainer(s).

102. A ball coupling device according to statement 100 or 101, wherein the operative portion of the lever is distal of said proximal portion.

103. A ball coupling device according to statement 102 as appended to statement 101, wherein the operative portion is distal of the lever portion that is pivotally coupled.

104. A ball coupling device according to any one of statements 96 to 103, configured such that the proximal portion is biased against the fulcrum during movement of the cover and/or retainer(s) in a direction from the operative position/engaged condition to the inoperative position/disengaged condition.

105. A ball coupling device according to statement 91 or any one of statements 92 to 104 as dependent therefrom, including an element fitted to the latch, and comprising: a key portion projecting from the latch into a radially outwardly opening void formed in a pin via which the latch is rotatably mounted, precluding relative translation between the latch and pin along an axis of the pin, so as to retain the pin and latch together; and a stop portion, projecting from the latch to define said stop.

106. A ball coupling device according to statement 105, wherein the pin is configured with a radially outwardly opening circumferential groove defining said void.

107. A ball coupling device according to statement 105 or 106, wherein the element and pin are engaged rotationally slidably or rotationally fixedly relative to the pin axis.

108. A ball coupling device according to any one of statements 105 to 107, wherein the element is fitted in or through a hole through the latch.

109. A ball coupling device according to statement 91 any one of statements 92 to 104 as dependent therefrom, or any one of statements 105 to 108, wherein the latch component comprises a periphery or edge configured to abut the stop to preclude said movement of the latch component beyond the locking position.

110. A ball coupling device according to any one of the preceding statements, including a mounting structure, via which the device is securable to a load to be towed, such as a trailer, caravan or other vehicle, and a shaft rotatably mounted to the mounting structure, via which the assembly or the at least one member or element is supported from the mounting structure such that there is permitted relative rotation between the mounting structure and the assembly or the at least one member or element about an axis of rotation perpendicular to said central and rotational axes.

111. A ball coupling device according to statement 110, wherein the support structure comprises a housing, and the shaft is rotatably supported in the housing.

112. A ball coupling device according to either one of statements 110 and 111, further including a fastening component to secure rotatably to the support structure an end of the shaft that projects from the support structure.

113. A ball coupling device according to statement 112, wherein the fastening component and support structure are arranged in abutting relation such that the shaft is retained axially relative to the support structure.

114. A ball coupling device according to statement 113, including an intermediate element arranged between the fastening component and housing such that the support structure and fastening component abut indirectly.

115. A ball coupling device according to statement 114, wherein the intermediate element comprises a washer.

116. A ball coupling device according to any one of statements 113 to 115, wherein said end and the fastening component have mating threads via which they are interconnected.

117. A ball coupling device according to statement 116, including a retaining device to retain together the shaft and fastening component, the retaining device comprising first and second elements, wherein the first element is formed with a thread mating with a thread of the shaft to connect the first element or retaining device to the shaft, and wherein the first and second elements are configured with mating threads such that the/each second element is translationally displaced relative to the first element so as to be in abutment with the fastening component, whereby the fastening component and the/each second element, and/or the mating threads of the shaft and fastening component, are urged into tight engagement to preclude relative rotation between the shaft and fastening component tending to loosen the fastening component.

118. A device for retaining together components that are interconnected via mating threads, the device comprising first and second elements configured with mating threads such that the/each second element is rotatable to be translationally displaced relative to the first element, wherein the first element is formed with a thread mateable with a thread of one of the components to connect the first element/device to that component whereby the/each second element can be rotated and thus translationally displaced into abutment with the other component, whereby the said other component and the/each second element, and/or the mating threads of the components, are urged into tight engagement to preclude relative rotation, tending to loosen the interconnection, between the components.

119. A device according to statement 118, for use as the retaining device in a ball coupling device according to statement 117, whereby the shaft defines said one component and the fastening component defines said other component.

120. A device according to any one of statements 117 to 119, wherein the thread with which said first element is formed is internal such that the thread of said one component with which it mates is an external thread of that component.

121. A device according to statement 120, wherein said first element is annular.

122. A device according to statement 120 or 121, wherein said first element comprises a nut or collar.

123. A device according to any one of statements 120 to 122, wherein the first element comprises a body arranged to abut the said other component, and wherein the said threads with which the first and second elements are configured are internal to the body and external respectively, so as to mate within the body.

124. A device according to statement 123, wherein the or each second element comprises a screw.

125. A device according to statement 123 or 124, wherein the or each screw is headless or comprises a grub screw.

126. A device according to statement 125, wherein the or each screw is configured at a trailing end thereof with a formation, such as a socket or a groove, engageable by a driving tool so as to be driveable by the tool.

127. A device according to any one of statements 117 to 126, wherein the first element is formed with a said thread which is not concentric with the threads with which the first and second elements are configured.

128. A device according to statement 127 as appended to any one of statements 123 to 126, comprising plural second elements spaced around the body.

129. A device according to statement 128, wherein the second elements are received or receivable by the body at diametrically opposite positions.

130. A device according to any one of statements 117 to 129, wherein at least one said second element comprises a portion arranged to form an indentation or depression in a surface abutted thereby, whereby there is formed a mechanical interlock, comprising the indentation or depression and the said portion received thereby, resisting relative rotation tending to loosen the fastening component.

131. A device according to statement 130, wherein the indentation- or depression-forming portion is defined by a tip of the second element.

132. A device according to statement 131, wherein the tip is cupped and/or hardened.

1. A ball coupling device comprising a socket assembly, configured to assume an operative condition in which it defines a socket to capture a tow ball such that there is formed a sliding fit, permitting relative rotation, between the tow ball and socket or assembly, and to assume an inoperative condition whereby the tow ball and assembly can be decoupled, the assembly being
configured to define in the operative condition an opening, disposed about a neck via which the tow ball is supported, having a width, parallel to a rotational axis extending centrally through the tow ball and perpendicular to a central axis of the tow ball that extends top-to-bottom therethrough, sufficient that the neck passes through the opening, and a length sufficient to permit relative displacement between the neck and assembly and thus relative rotation between the tow ball and the assembly or device about said rotational axis.

2. A ball coupling device comprising a socket assembly, configured to assume an operative condition in which it defines a socket to capture a tow ball such that there is formed a sliding fit, permitting relative rotation, between the tow ball and socket or assembly, and to assume an inoperative condition whereby the tow ball and assembly can be decoupled, the assembly being configured so as to be, in the operative condition, engageable with the tow ball at a region between an equator of the tow ball and a neck via which the tow ball is supported, precluding relative translation between the assembly and tow ball along a central axis such that they cannot be decoupled, and so as to be, in the inoperative condition, not engageable with the tow ball at said region, permitting said relative translation such that movement of the device or assembly relative to the tow ball, to separate the former from the latter, along the central axis is unobstructed by the device.

3. A ball coupling device according to claim 1 or 2, wherein the socket assembly comprises at least one member or element (“member/element”) adapted to engage in said operative condition a respective one of convex portions of a tow ball arranged about said central axis.

4. A ball coupling device according to claim 1 or 2, comprising members or elements shaped to define concavities complementary in profile to respective convex portions of said tow ball arranged about said central axis and extending top-to-bottom therethrough, the members or elements (“members/elements”) being adapted to assume an operative condition in which the concavities are arranged to engage said portions whereby the tow ball is captured thereby such that there is formed a sliding fit, permitting relative rotation about the central axis, between the members/elements and tow ball, and to assume an inoperative condition whereby the tow ball and the members/elements or device can be decoupled, wherein the members/elements are configured to define in the operative condition a said opening, disposed about a neck via which the tow ball is supported, having a width, parallel to a rotational axis extending centrally through the tow ball and perpendicular to said central axis, sufficient that the neck passes therethrough, and a length sufficient to permit relative displacement between the neck and members/elements therealong and thus relative rotation between the tow ball and the members/elements or device about the rotational axis.

5. A device according to claim 1 or 2, wherein said assembly, or at least one member or element of which it is comprised, is configured such that lengthways extension of an/the opening disposed about the neck is circumferential about said rotational axis, and/or wherein peripheral portions of the assembly or at least one member/element arranged to define an/the opening disposed about the neck are profiled to extend circumferentially about said rotational axis when the operative condition is assumed.

6. A device according to claim 1 or 2, wherein said assembly, or at least one member or element of which it is comprised, comprises or defines jaws, members/elements defining clasp members or elements, or opposed members or elements.

7. A device according to claim 1 or 2, wherein the assembly, or at least one member or element of which it is comprised, comprises a member/element that is pivotally moveable, to assume the inoperative and operative conditions, at least one member/element being arranged to pivot about an upper end thereof.

8. A device according to claim 1 or 2, wherein:
the socket assembly comprises a support and at least one member or element mounted to the support to be moveable relative thereto, to assume said operative and inoperative conditions; and/or
the device comprises a support to which said at least one member or element is mounted to be moveable relative thereto, to assume the operative and inoperative conditions.

9. A device according to claim 1 or 2, wherein the assembly, or at least one member/element of which it is comprised, comprises clasp or wall portions in which are formed concavities complementary in profile to respective convex portions of the tow ball arranged to engage said convex portions when in the operative condition, the device being configured to define, when the assembly or at least one member/element is in the operative condition, an enclosure to enclose the tow ball, the enclosure comprising said clasp or wall portions.

10. A device according to claim 9, wherein the clasp or wall portions comprise side wall portions and the concavities comprise side concavities which open through inner faces of said side wall portions arranged to lie in opposed relation in the operative condition, and wherein the wall portions comprise end wall portions which extend transverse to the side wall portions, and the concavities comprise end concavities which open through inner faces of the end wall portions.

11. A device according to claim 1 or 2, comprising a mounting structure via which it is securable to a load to be towed, such as a trailer, caravan or other vehicle, wherein the assembly or at least one member or element of which it is comprised is rotatable relative to the mounting structure about an axis of rotation perpendicular to said central and rotational axes, and wherein the assembly or at least one member/element is coupled to the mounting structure via a support, to which one or more members/elements are moveably mounted, the support being supported from the mounting structure such that it is rotatable relative thereto about said axis of rotation, the device including a shaft to which the support is connected and which is rotatably mounted to said mounting structure.

12. A device according to claim 11, including a single piece defining said shaft and support, wherein the shaft and support are integrally formed.

13. A device according to claim 1 or 2, said rotational axis being a laterally extending axis.

14. A device according to claim 1 or 2, wherein said assembly or at least one member or element of which it is comprised is resiliently biased towards said inoperative condition.

15. A ball coupling device comprising a socket assembly or at least one member or element (“member/element”) configured to assume an operative condition in which the socket assembly defines a socket configured to capture a tow ball or the member(s)/element(s) is/are arranged to lie closely adjacent said tow ball whereby the tow ball is captured by the device such that there is formed a sliding fit, permitting relative rotation, between the tow ball and socket or assembly or member(s)/element(s), and an inoperative condition whereby the tow ball is not captured by the assembly or which is such that the tow ball is not captured by the assembly, the device including or further comprising either or each of:
a cover moveable between an operative position in which it covers said assembly or member(s)/element(s) in the operative condition, and an inoperative position permitting the socket assembly to assume the inoperative condition or whereby the member(s)/element(s) is/are permitted to move such that the inoperative condition is assumed; and
at least one retainer placeable into an engaged condition in which the at least one retainer holds the socket assembly or member(s)/element(s) in the operative condition, and a disengaged condition permitting the socket assembly to assume the inoperative condition.

16. A ball coupling device according to claim 15, wherein the cover comprises a housing arranged so as to house the element(s)/member(s) or the assembly in the operative condition.

17. A ball coupling device according to claim 15, wherein the cover is configured such that in the operative position it engages or abuts the assembly or at least one element/member to retain the element(s)/member(s)/socket in the operative condition.

18. A ball coupling device according to claim 15, including a locking mechanism operable to lock the retainer(s) in the engaged condition or the cover in the operative position and releasable so as not to preclude the disengaged condition or inoperative position from being assumed.

19. A ball coupling device according to claim 15, including a latch moveable between a locking position in which it is arranged to act between the retainer(s) or cover and the assembly or member(s)/element(s), to lock the retainer(s) in the engaged condition or the cover in the operative position, and a released position in which it is arranged not to preclude the retainer(s) from assuming a said disengaged condition or the cover from assuming a said inoperative position.

20. A ball coupling device according to claim 19, including a portion engageable by the latch, the engageable portion being interconnected with and/or defined by one of the cover or at least one retainer and the assembly/at least one member/element, wherein the latch is moveably coupled to or supported from the other of the cover or at least one retainer and the assembly/at least one member/element to be moveable, relative to said other, between position in which the latch engages the engageable portion, being said locking position, and a position in which the latch is disengaged from the engageable portion, being said released position.
